(19) United States
(12) Patent Application Publication
(10) Pub. No.: US 2017/0093739 A1
(43) Pub. Date: Mar. 30, 2017

(54) APPARATUS TO REDUCE A LOAD FOR BANDWIDTH CONTROL OF PACKET FLOWS

(71) Applicant: FUJITSU LIMITED, Kawasaki-shi (JP)

(72) Inventor: Atsushi KITADA, Kawasaki (JP)

(21) Appl. No.: 15/259,313

(22) Filed: Sep. 8, 2016

(30) Foreign Application Priority Data
Sep. 25, 2015 (JP) 2015-188822

(51) Int. Cl. H04L 12/863; H04L 12/873; H04L 12/825; H04L 12/851

(52) U.S. Cl. CPC H04L 47/621; H04L 47/2441; H04L 47/52; H04L 47/25

(57) ABSTRACT

An apparatus includes queues each configured to store packets for a different one of flows. The apparatus reads out packets from each of the queues according to an allowable readout amount supplied for the flow, and outputs the packets to one of ports corresponding to the flow. The apparatus executes a readout amount supply process on a port sequentially selected from the ports, where the readout amount supply process includes selecting a flow from first flows corresponding to the selected port, and supplying the allowable readout amount to the selected flow. The apparatus controls execution of the readout amount supply process so that the allowable readout amount increases when the selected flow is bandwidth-guaranteed, and the allowable readout amount is also supplied to flows other than the selected flow within the first flows before selecting a next port from the ports when the selected flow is not bandwidth-guaranteed.

### CROSS-REFERENCE TO RELATED APPLICATION

This application is based upon and claims the benefit of priority of the prior Japanese Patent Application No. 2015-188822, filed on Sep. 25, 2015, the entire contents of which are incorporated herein by reference.

### FIELD

The embodiments discussed herein are related to apparatus to reduce a load for bandwidth control of packet flows.

### BACKGROUND

Accompanying an increase in a communication demand, the bandwidth of traffic that flows through a network has been increasing. Therefore, for example, a measure, in which a bandwidth of traffic for each user is controlled, is adopted in a router and a layer 2 switch in the network.

For example, in Japanese Laid-open Patent Publication No. 2014-135581, a method has been disclosed in which, when packets are read out from queues, a bandwidth is controlled by consuming credit that is assigned to each of plural queues by a scheduler unit. This method allows a credit amount worth of packets to be read out at a time. This thereby enables a queue, from which packets are read, to be selected for each credit amount supplied and not for each packet. This reduces the number of times queues are selected for reading.

For example, in a case in which a queue is selected for each packet, in scheduling of 64 (Byte), the shortest frame length in 100 (Gbps) Ethernet (registered trademark, the same applies hereinafter), a selection processing of approximately 150 M (times/second), at an interval of 6.72 (ns) is desirable. However, in a case in which a queue is selected for each amount of credit supply, for example, assuming the credit supply of 10 (KByte), a selection processing of approximately 1.25 M (times/second), at 800 (ns) interval will suffice. Further, if a 10 times credit supply, 100 (KByte) is assumed, it is sufficient to execute the selection processing of approximately 125K (times/second), at 8 (μs) interval.

### SUMMARY

According to an aspect of the invention, an apparatus includes a plurality of queues each configured to store packets for different one of a plurality of flows. The apparatus reads out packets from each of the plurality of queues according to an allowable readout amount supplied for a flow corresponding to the each queue, and outputs the packets to one of ports corresponding to the flow, where the allowable readout amount is an amount of data for packets that are allowed to be read out at one time from a queue. The apparatus executes a readout amount supply process on a port sequentially selected from the ports, where the readout amount supply process includes selecting a flow from first flows corresponding to the selected port, and supplying the allowable readout amount to the selected flow. The apparatus controls execution of the readout amount supply process so that the allowable readout amount increases when the selected flow is a flow whose bandwidth is guaranteed, and the allowable readout amount is also supplied to each of flows other than the selected flow within the first flows before a next port is selected from the ports when the selected flow is a flow whose bandwidth is not guaranteed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a communication device, according to an embodiment;

FIG. 2 is a diagram illustrating an example of a configuration of an interface card, according to an embodiment;

FIG. 3 is a diagram illustrating an example of a configuration of a bandwidth control device, according to an embodiment;

FIG. 4 is a diagram illustrating an example of an operational flowchart for processing of a load monitoring unit, according to an embodiment;

FIG. 5 is a diagram illustrating an example of an operational flowchart for processing of a load monitoring unit, according to an embodiment;

FIG. 6 is a diagram illustrating an example of an operational flowchart for processing of a credit control unit, according to an embodiment;

FIG. 7 is a diagram illustrating an example of a flow management table, according to an embodiment;

FIG. 8 is a diagram illustrating an example of an operational flowchart for processing of a request reception unit, according to an embodiment;

FIG. 9 is a diagram illustrating an example of an operational flowchart for scheduling processing, according to an embodiment;

FIG. 10 is a diagram illustrating an example of an operational flowchart for skip processing, according to an embodiment;

FIG. 11 is a diagram illustrating an example of an operation of credit supply to a non-bandwidth-guaranteed flow during low load, according to an embodiment;

FIG. 12 is a diagram illustrating an example of an operation of credit supply to a non-bandwidth-guaranteed flow during high load, according to an embodiment;

FIG. 13 is a diagram illustrating an example of an operation of credit supply to a bandwidth-guaranteed flow during high load, according to an embodiment;

FIG. 14 is a diagram illustrating an example of an operational sequence for credit supply to a non-bandwidth-guaranteed flow and a bandwidth-guaranteed flow during high load, according to an embodiment;

FIG. 15 is a diagram illustrating an example of an operation of credit supply to a non-bandwidth-guaranteed flow during high load, according to an embodiment;

FIG. 16 is a diagram illustrating an example of an operational sequence for credit supply to a non-bandwidth-guaranteed flow during high load, according to an embodiment;

FIG. 17 is a diagram illustrating an example of an operational flowchart for processing in a credit control unit, according to an embodiment;

FIG. 18A is a diagram illustrating an example of a port management table during low load, according to an embodiment;

FIG. 18B is a diagram illustrating an example of a port management table during high load, according to an embodiment;

FIG. 19A is a diagram illustrating an example of an operation of a request reception unit during low load, according to an embodiment;

FIG. 19B is a diagram illustrating an example of an operation of a request reception unit during high load, according to an embodiment;

FIG. 20 is a diagram illustrating an example of priority control processing of a request message, according to an embodiment; and

FIG. 21 is a diagram illustrating an example of a configuration of a bandwidth control system, according to an embodiment.

### DESCRIPTION OF EMBODIMENTS

In the above-described method, as amount of credit supply increases, the number of times of selection of a queue is reduced, so that a processing load of supplying credit in the scheduler unit is reduced. On the other hand, amount of data for packets read from a queue at a time increases.

When the data amount of the packets read at a time increases, the burstiness of traffic increases. In this case, for example, the quality of a real-time communication service such as a voice over internet protocol (VoIP) and video distribution is reduced. Therefore, it is desirable that an amount of credit supply is smaller from the burstiness point of view.

However, for example, when the scheduler unit is configured by software using a processor such as a central processing unit (CPU), a load to the processor for the scheduler unit may vary depending on the occurrence of processing other than the processing of credit supply. In this case, during low load, the scheduler unit may be able to supply the credit at a high frequency by reducing the amount of credit supply (for example, 10 (KByte)). However, during high load, output rate of packets may be lowered because the credit supply processing is unable to keep pace with the packet reading processing.

In addressing this, it is conceivable that an amount of credit supplied is changed according to a load to the scheduler unit. However, when an amount of credit supply is changed halfway through a sequential selection of queues to be supplied with credit, a difference in amount of packets being read out occurs between queues, making control of bandwidth among flows of packets for the respective queues inequitable. Moreover, the supply of credit is performed triggered by an input of a packet to a queue, thus making it difficult to predetermine an appropriate timing at which amount of credit is to be changed.

Therefore, the technology discussed herein is made by considering the above-described problem, and it is desirable to provide a bandwidth control device and a bandwidth control system each of which reduces a load of bandwidth control processing without impairing equity of bandwidth control among flows.

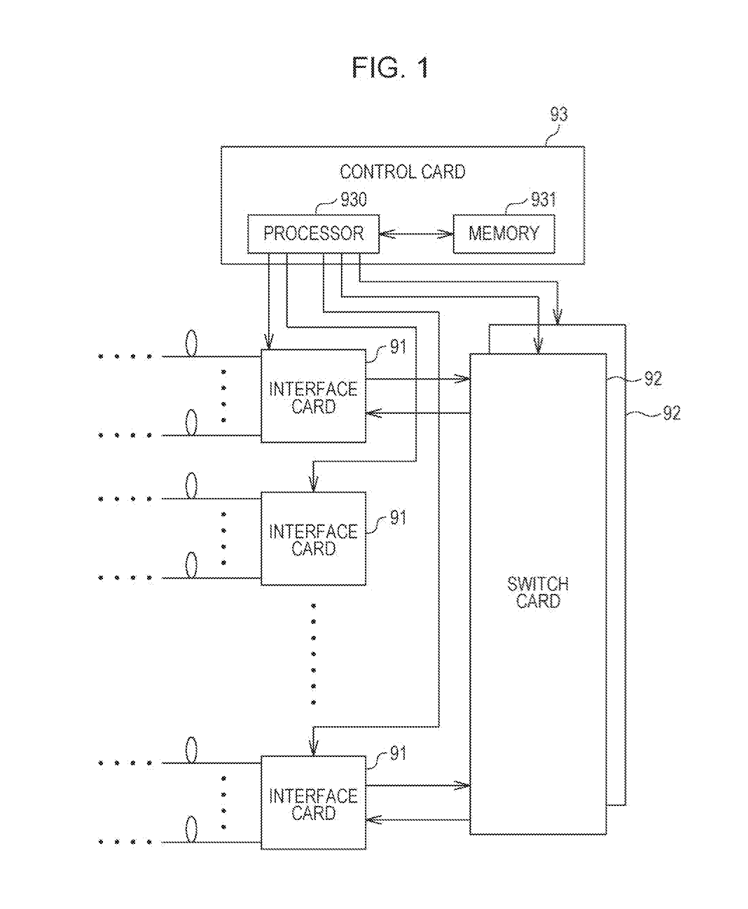

FIG. 1 is a configuration diagram illustrating an example of a communication device. The communication device includes plural interface cards 91, two switch cards 92, and a control card 93. Each of the cards 91 to 93 is housed in an individual slot provided in a housing, and electrically coupled to each other. Note that, the present specification refers to a layer 2 switch, a router, and the like as examples of communication devices provided with a bandwidth control device according to an embodiment, however, the embodiments are not limited thereto, and the bandwidth control device according to the embodiment is similarly provided, for example, to other types of communication devices such as a wavelength multiplexing transmission device.

The communication device relays packets received from one device to another device in accordance with the destination of the packets. Note that, the present specification refers to a packet as a protocol data unit (PDU), this being a unit of transmission of data (information), with an Ethernet frame as an example. However, the embodiment is not limited thereto, and other PDUs such as an Internet Protocol (IP) packet may be employed as a packet.

Each of the interface cards 91 transmits and receives packets to and from other devices. Other devices may include, for example, a terminal device such as a personal computer, a server, and a router. The interface cards 91 are coupled to optical fibers through plural ports, and perform communication, for example, based on the 10 GBASE-LR standard.

Each of the two switch cards 92 exchanges packets between the plural interface cards 91. More specifically, packets are input to the switch card 92 from the interface card 91, and the switch card 92 outputs packets to the interface card 91 according to the destination of the packets. The two switch cards 92 are used, for example, as an active system and a standby system in preparation for a failure such as a hardware fault.

The control card 93 controls the plural interface cards 91 and the two switch cards 92. The control card 93 is coupled to a network control device and the like, and executes processing related to user interface, setting processing for each of the cards 91 and 92, data collection processing from each of the cards 91 and 92, and the like. The control card 93 includes a processor 930 such as a CPU that executes such processing, and a memory 931 that stores a program that drives the processor 930.

In addition, a traffic bandwidth control function may be provided in the control card 93. Such a function is realized through network functions virtualization (NFV), for example, by the processor 930, namely by software.

However, it is difficult to realize all of the bandwidth control processing of traffic that exceeds 100 (Gbps) by the processor 930, from the point of view of processing speed. Therefore, as described later, out of the bandwidth control processing, it is desirable that, for example, input/output processing of packet queue is assigned to the hardware in the interface card 91, and scheduling processing such as quality of service (QoS) related bandwidth allocation and priority control is assigned to the software.

In this case, use of software according to a particular carrier operating the communication device enables appropriate scheduling processing in accordance with the specifications by the carrier. However, bandwidth control processing is not limited thereto, and all of the bandwidth control processing may be provided in the interface card 91.

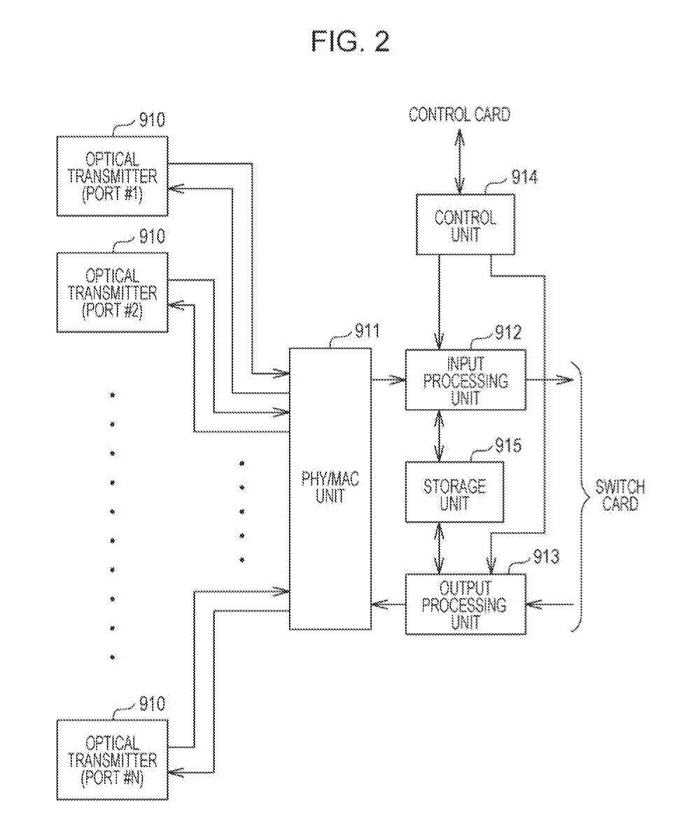

FIG. 2 is a configuration diagram illustrating a function configuration of the interface card 91. The interface card 91 includes plural optical transceivers 910, a PHY/MAC unit 911, an input processing unit 912, an output processing unit 913, a control unit 914, and a storage unit 915.

Each of the plural optical transceivers 910, for example, is a small form factor pluggable (SFP), converts an optical signal received from another device through an optical fiber into an electrical signal, and outputs the electrical signal to the PHY/MAC unit 911. Each of the plural optical transceivers 910 also converts an electrical signal input from the PHY/MAC unit 911 into an optical signal and transmits the optical signal to another device through the optical fiber. Namely, the plural optical transceivers 910 function as plural ports #1 to #N (N: a positive integer) to transmit and receive a packet to and from other devices.

The PHY/MAC unit 911 executes establishment processing of a link with another device, distribution processing of packets to the plural optical transceivers 910, and the like. The PHY/MAC unit 911 outputs packets that have been input from the plural optical transceivers 910 to the input processing unit 912, and outputs packets that have been input from the output processing unit 913 to the plural optical transceivers 910.

The input processing unit 912 and the output processing unit 913 are logic circuits such as a field programmable gate array (FPGA) or an application specific integrated circuit (ASIC), and respectively execute INGRESS and EGRESS packet processing. The input processing unit 912 executes input rate control processing and the like of packets from the PHY/MAC unit 911, and outputs the packets to the switch card 92.

The output processing unit 913 executes bandwidth control processing and the like for each flow of packets that have been input from the switch card 92, and outputs the packets to the PHY/MAC unit 911. The storage unit 915 is a means for storing data, such as a memory, and stores various kinds of data used for processing by the input processing unit 912 and the output processing unit 913.

The control unit 914 communicates with the control card 93 and controls the input processing unit 912 and the output processing unit 913. The control unit 914 includes a processor such as a CPU and a memory (not illustrated in the drawings). Processing by the control unit 914 includes, for example, various kinds of setting processing in the input processing unit 912 and the output processing unit 913, and collection and processing of warnings detected in the input processing unit 912 and the output processing unit 913. Note that some of the bandwidth control processing may be realized through software processing in the control unit 914.

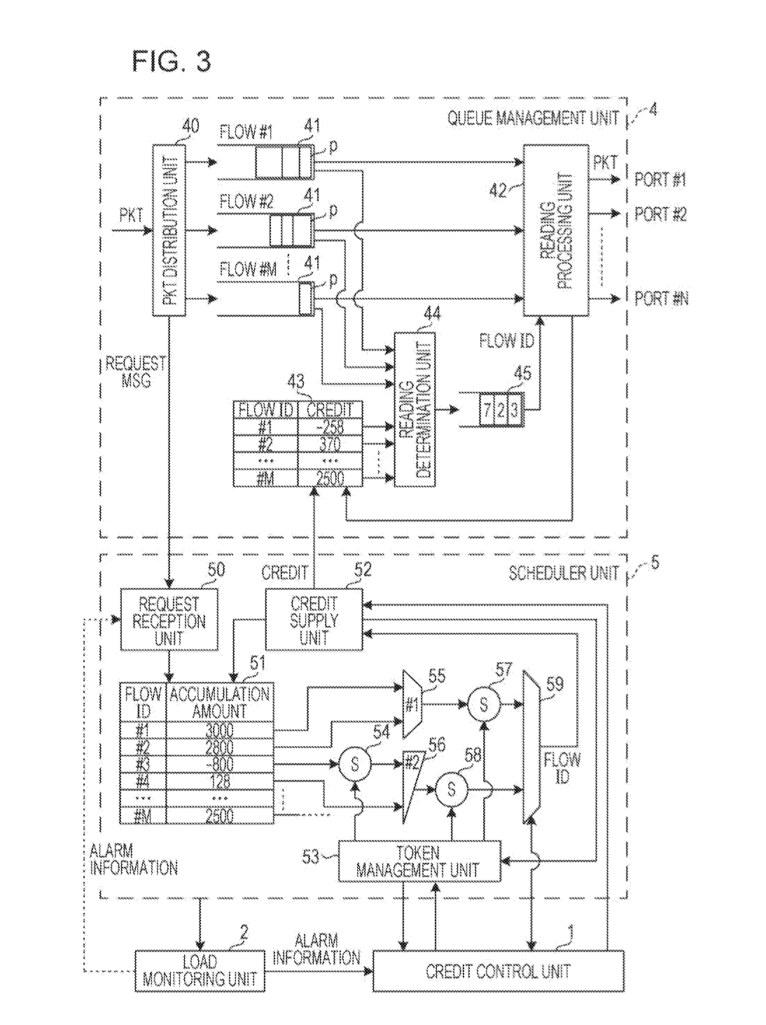

FIG. 3 is a configuration diagram illustrating the bandwidth control device according to the embodiment. The bandwidth control device performs, for each of the flows, the bandwidth control of packets output from the output processing unit 913 to each of the ports #1 to #N through the PHY/MAC unit 911. Namely, the bandwidth control device executes the above-described bandwidth control processing.

The bandwidth control device includes a credit control unit 1, a load monitoring unit 2, a queue management unit 4, and a scheduler unit 5. The queue management unit 4 executes input/output processing of a packet queue and the like, and is provided, for example, to the output processing unit 913. The scheduler unit 5 executes scheduling processing such as QoS related bandwidth allocation and priority control, and is configured, for example, as a function of the processor 930 in the control card 93.

The load monitoring unit 2 is an example of a monitoring unit, monitors a processing load of the scheduler unit 5, and is provided, for example, to a hardware in the control card 93. For example, when the scheduler unit 5 is configured by a CPU, the load monitoring unit 2 monitors a CPU usage rate.

The credit control unit 1 is an example of a control unit and controls a credit amount and the like supplied from the scheduler unit 5 to the queue management unit 4. The credit amount is an example of amount of data for packets that are allowed to be read at one time from a queue 41 in the queue management unit 4, namely, an allowable readout amount. The credit control unit 1 controls the scheduler unit 5 according to a monitoring result of the load monitoring unit 2, such that the processing load of the scheduler unit 5 is reduced dynamically. The detail of a function of each of the units is described below.

The queue management unit 4 includes a packet (PKT) distribution unit 40, plural queues 41 storing packets p for each of the flows #1 to #M (M: an integer), a reading processing unit 42, a credit table 43, a reading determination unit 44, and a reading order registration first in first out (FIFO) 45.

The PKT distribution unit 40 identifies flows #1 to #M of packets input from the switch card 92, and inputs the packets to the queue 41 corresponding to each of the flows #1 to #M. Namely, the PKT distribution unit 40 distributes packets to the plural queues 41. The PKT distribution unit 40 identifies the flows #1 to #M based on, for example, a virtual local area network (VLAN) tag and the like attached to the packet.

The queue 41, which is an example of a packet storage unit, is provided to each of the flows #1 to #M, and stores packets p. The packets p are stored in the queue 41 corresponding to each of the flow #1 to #M and are read by the reading processing unit 42 in the storage order. The reading processing unit 42, which is an example of an output unit, reads the packets p from the queue 41 based on a credit amount supplied for each of the flows #1 to #M, and outputs the packets p to the ports #1 to #N corresponding to the each flow.

The credit amount is an example of an allowable readout amount that is an amount of data for packets p allowed to be read from the queue 41. The reading processing unit 42 consumes credit to read packets p. Thus, the reading processing unit 42 is able to read a credit amount worth of packets p at one time. Accordingly, it is sufficient that the reading processing unit 42 selects a queue 41 to read from, for each credit amount rather than for each packet p.

The credit table 43 manages a credit amount for each of the flows #1 to #M. The credit is supplied from the scheduler unit 5 in a fixed amount for each of the flows #1 to #M. The credit amount in the credit table 43 is added to with a supply of credit. When the reading processing unit 42 reads out packets p, the reading processing unit 42 subtracts the credit amount in the credit table 43 by the amount of data for the packets p that have been read out. The credit table 43 is configured, for example, by a memory, a counter, or the like.

In the example of FIG. 3, a credit amount of the flow #1 is −258 (Byte), and a credit amount of the flow #2 is 360 (Byte). Since the reading processing unit 42 reads packets p when the credit amount is larger than 0, the credit amount may exhibit a negative value. For example, in a case in which the credit amount is 10 (byte), when a packet p of the 64 (Byte) length has been read, the credit amount is −54 (Byte) (=10−64).

The reading determination unit 44 determines whether or not packets p for each of the flows #1 to #M are allowed to be read out, based on the data amount for the packets p stored in the queue 41 and the credit amount in the credit table 43. The reading determination unit 44 registers a flow ID (#1 to #M) of a flow of packets determined to be readable, in the reading order registration FIFO 45.

More specifically, the reading determination unit 44 determines, for each of the flows #1 to #M, whether or not the readout conditions, “data amount of packets p in the queue 41>0” and “credit amount>0”, are satisfied, and registers flow IDs of the flow that satisfies the readout condition in the reading order registration FIFO 45 in chronological order. In the example of FIG. 3, since the reading condition was satisfied in the order of the flows #3, #2, and #7, the flow IDs are registered in the reading order registration FIFO 45 in the order of flow IDs of “3”, “2”, and “7”. Note that since the credit amount of the flow #1 is a negative value (−258 (Byte)), the readout condition is not satisfied.

The flow IDs of the flows that satisfy the readout conditions are registered in the reading order registration FIFO 45 in chronological order. The reading processing unit 42 reads out a flow ID from the reading order registration FIFO 45 in the registration order, and reads out packets p from the queue 41 corresponding to the flow ID that has been read out.

In this manner, the reading processing unit 42 may easily select the queue 41 to read, enabling the load of the selection processing in the queue 41 to be reduced.

The PKT distribution unit 40 is an example of a request unit, and each time a packet is input to the queue 41, the PKT distribution unit 40 requests credit in a fixed amount from the scheduler unit 5. The PKT distribution unit 40 outputs a request message (MSG) for credit to the scheduler unit 5, when a packet is input to the queue 41.

The PKT distribution unit 40 detects a flow ID and a data amount of packets, namely, a packet length, and stores the flow ID and the packet length in the request message. The data amount of the packets p input to the queue 41 is accordingly notified to the scheduler unit 5 for each of the flows #1 to #M.

The scheduler unit 5 includes a request reception unit 50, an accumulation amount table 51, a credit supply unit 52, a token management unit 53, a flow shaper 54, a normal flow selection unit 55, a priority flow selection unit 56, port shapers 57 and 58, and a port selection unit 59. Only one each of flow shaper 54, normal flow selection unit 55, priority flow selection unit 56, port shapers 57 and 58, and port selection unit 59 are illustrated here, but a plurality thereof may be provided.

The request reception unit 50 accepts the request message from the PKT distribution unit 40 and registers the data amount indicated in the request message at the accumulation amount table 51. In the accumulation amount table 51, a virtual accumulation amount of packets p accumulated in the queue 41 is registered for each of the flows #1 to #M. The accumulation amount table 51 is configured, for example, by a memory, a counter, or the like.

The request reception unit 50 obtains the flow ID and the packet length from the accepted request message, and adds the packet length to the accumulation amount for the corresponding flow ID in the accumulation amount table 51. In addition, the credit supply unit 52 supplies credit for each of the flows #1 to #M and subtracts the supplied credit amount from the accumulation amount for the corresponding flow ID in the accumulation amount table 51. At this time, the supplied credit amount is assumed to be the data amount of packets p read out by the reading processing unit 42.

However, as described above, the reading processing unit 42 may read packets that exceed the credit amount because the reading processing unit 42 reads packets p as long as “credit amount in the credit table 43>0” is satisfied. Therefore, there is an error between the credit amount that has been supplied by the scheduler unit 5 and the data amount of the packets that has been read by the reading processing unit 42. In addition, when the supply rate of the credit exceeds the input rate of the packets, the accumulation amount of the accumulation amount table 51 may exhibit a negative value.

Thus, the accumulation amount of the accumulation amount table 51 is a virtual value different from the actual accumulation amount of the packets p in the queue 41. A flow to be supplied with credit out of the flows #1 to #M is selected based on the accumulation amount in the accumulation amount table 51.

Each of the port selection unit 59, the normal flow selection unit 55, and the priority flow selection unit 56 selects one of the flows #1 to #M to be supplied with credit, and notifies the credit supply unit 52 of the flow ID of the selected flow. The port selection unit 59, the normal flow selection unit 55, and the priority flow selection unit 56 are arranged hierarchically based on corresponding relationships between the flows #1 to #M and the ports #1 to #N and corresponding relationships among the flows #1 to #M.

In FIG. 3, as an example, arrangement of the port selection unit 59, the normal flow selection unit 55, and the priority flow selection unit 56 for the flows #1 to #4 is illustrated. Here, it is assumed that packets of the flows #1 and #2 are output to the same port #1 without the bandwidth of either the flow #1 or the flow #2 guaranteed, either flow being a so-called best-effort basis flow (hereinafter referred to as a “non-bandwidth-guaranteed flow”). In addition, it is assumed that packets of the flows #3 and #4 are output to the same port #2, and only the bandwidth for the flow #3 is guaranteed (hereinafter referred to as a “bandwidth-guaranteed flow”).

The normal flow selection unit 55 corresponds to the port #1 and obtains the accumulation amounts for the flow #1 and the flow #2 from the accumulation amount table 51. The priority flow selection unit 56 corresponds to the port #2 and obtains the accumulation amounts for the flow #3 and the flow #4 from the accumulation amount table 51.

The port selection unit 59 sequentially selects a port from the ports #1 to #N in this order. More specifically, the port selection unit 59 selects the normal flow selection unit 55 corresponding to the port #1 and the priority flow selection unit 56 corresponding to the port #2 alternately. At this time, the normal flow selection unit 55 is capable of selecting the flows #1 and #2, under the control of the normal flow selection unit 55 to be supplied with credit when a token amount accumulated in a token bucket for the port shaper 57 is larger than 0, and is not capable of selecting the flows #1 and #2 under the control of the normal flow selection unit 55 to be supplied with credit when the token amount is 0 or less. In addition, the priority flow selection unit 56 is capable of selecting the flows #3 and #4 under the control of the priority flow selection unit 56 to be supplied with credit when a token amount accumulated in a token bucket for the port shaper 58 is larger than 0, and is not capable of selecting the flows #3 and #4 under the control of the priority flow selection unit 56 to be supplied with credit when the token amount is 0 or less.

The port shapers 57 and 58 are supplied with tokens from the token management unit 53. The output rate of the port #1 is controlled based on the supply rate of tokens by the port shaper 57, and the output rate of the port #2 is controlled based on the supply rate of tokens by the port shaper 58.

In this manner, the token amounts for the port shapers 57 and 58 are bandwidth amounts allocated for the ports #1 and #2, respectively, and the credit supply unit 52 supplies credit to one of flows #1 to #M being selected, based on the token amounts for the port shapers 57 and 58.

The normal flow selection unit 55 selects one of the flows #1 and #2 each time the normal flow selection unit 55 is selected by the port selection unit 59. The normal flow selection unit 55 selects the flow #1 and the flow #2 in an equitable manner, for example, based on a round-robin scheme. The normal flow selection unit 55 obtains an accumulation amount for the selected flow #1, #2 from the accumulation amount table 51 and notifies the port selection unit 59 of the accumulation amount.

In addition, the priority flow selection unit 56 selects one of the flows #3 and #4 each time the priority flow selection unit 56 is selected by the port selection unit 59. The priority flow selection unit 56 selects the flow #3 with a priority out of the flows #3 and #4, based, for example, on a “Strict Priority” scheme.

At this time, the flow #3 is capable of being selected when the token amount that has been accumulated in the token bucket for the flow shaper 54 is larger than 0, and is not capable of being selected when the token amount is 0 or less. The flow shaper 54 is supplied with tokens from the token management unit 53. The bandwidth for the flow #3 is guaranteed according to the supply rate of tokens to the flow shaper 54. The priority flow selection unit 56 obtains accumulation amounts for the selected flows #3, #4 and notifies the port selection unit 59 of the accumulation amounts.

The port selection unit 59 notifies the credit supply unit 52 of the flow ID of the selected one of flows #1 to #M when the accumulation amount for the flow notified from the normal flow selection unit 55 or the priority flow selection unit 56 is larger than 0. On the other hand, when the accumulation amount is 0 or less, the port selection unit 59 does not notify the flow ID of the selected flow, and selects a next port. Namely, the credit supply unit 52 selects one of flows #1 to #M that satisfies the supply conditions of “token amount>0” and “accumulation amount>0”, and supplies credit to the selected one of the flows #1 to #M. The selection order of the flows is described below using an example.

First, the port selection unit 59 selects the normal flow selection unit 55 corresponding to the port #1 when “token amount of the port shaper 57>0” is satisfied. The normal flow selection unit 55 selects the flow #1 and notifies the port selection unit 59 of the accumulation amount for the flow #1. The accumulation amount for the flow #1 is 3000 (>0), such that the port selection unit 59 notifies the credit supply unit 52 of the flow ID “#1”. The credit supply unit 52 accordingly supplies credit to the flow #1.

Next, the port selection unit 59 selects the priority flow selection unit 56 corresponding to the port #2 when “token amount of the port shaper 58>0” is satisfied. When “token amount of the flow shaper 54>0” is satisfied, the priority flow selection unit 56 selects the flow #3 and notifies the port selection unit 59 of the accumulation amount for the flow #3. Since the accumulation amount of the flow #3 is −800 (≦0), the port selection unit 59 does not notify the credit supply unit 52 of the flow ID “#3”. Therefore, the credit supply unit 52 does not supply credit to the flow #3. Note that, if “accumulation amount of the flow #3>0” is satisfied, credit are also supplied to the flow #3.

Next, the port selection unit 59 selects the normal flow selection unit 55 corresponding to the port #2 when “token amount of the port shaper 57>0” is satisfied. The normal flow selection unit 55 selects the flow #2 and notifies the port selection unit 59 of the accumulation amount for the flow #2. Since the accumulation amount of the flow #2 is 2800 (>0), the port selection unit 59 notifies the credit supply unit 52 of the flow ID #2. Therefore, the credit supply unit 52 supplies credit to the flow #2. From this point on, selection of one of the flows #1 to #M is similarly repeated.

In this manner, the scheduler unit 5 sequentially selects one of the ports #1 to #N, and each time a port is selected, selects a flow out of the flows #1 to #M that corresponds to the port selected, supplying credit to the selected flow. Accordingly, all of the flows #1 to #M are provided with an opportunity to be supplied with credit.

In addition, the token management unit 53 manages the output rate of packets in unit of port or in unit of flow. The token management unit 53 controls the supply rate of tokens to the flow shaper 54 based on a flow management table described later, and controls the supply rate of tokens to the port shapers 57 and 58 based on a port management table described later.

The credit supply unit 52 notifies the queue management unit 4 of amount of credit to supply and a flow ID of a flow to be supplied with credit. The credit table 43 is thereby updated. When the credit supply unit 52 supplies credit, the credit supply unit 52 notifies the token management unit 53 of the amount of credit supplied and the flow ID of the flow supplied with credit. The token management unit 53 subtracts the amount of credit supplied from the token amount for the port shaper 57 and 58 corresponding to the flow. In addition, in case of a bandwidth-guaranteed flow, the token management unit 53 subtracts the supplied credit amount from the token amount for the flow shaper 54 corresponding to the flow.

As described above, the load monitoring unit 2 monitors the load of the processing in the scheduler unit 5 and notifies the credit control unit 1 of the monitoring result as alarm information. The credit control unit 1 controls the amount of credit to be supplied by the credit supply unit 52 and the amount of tokens to be subtracted at the token management unit 53 in response to the alarm information. At this time, the credit control unit 1 obtains the flow ID of the flow being selected, from the port selection unit 59, and causes the control content to be different according to the types of the flow #1 to #M (bandwidth-control flow or non-bandwidth-control flow).

In this manner, since the credit control unit 1 controls the scheduler unit 5 according to the monitoring result by the load monitoring unit 2, the amount of credit supplied is controlled in a timely basis. As described later, the load monitoring unit 2 may notify the request reception unit 50 of the alarm information (see the dotted line in FIG. 3).

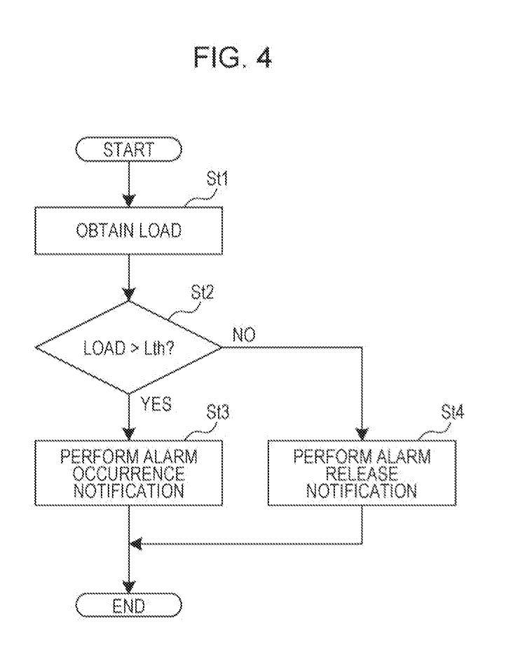

FIG. 4 is a flowchart illustrating an example of processing of the load monitoring unit 2. The processing is executed, for example, periodically.

First, the load monitoring unit 2 obtains a load of the processing of the scheduler unit 5 (Step St1). For example, when the scheduler unit 5 is configured as a function of a CPU, the load is determined based on a CPU usage rate and a memory usage rate.

Next, the load monitoring unit 2 compares the obtained load with a threshold value Lth (Step St2). When the load is the CPU usage rate, the threshold value Lth is, for example, 70(%).

When “load>Lth” is satisfied (“YES” in Step St2), the load monitoring unit 2 outputs alarm occurrence notification to the credit control unit 1 as alarm information (Step St3), and ends the processing. In addition, when “load≦Lth” is satisfied (“NO” in Step St2), the load monitoring unit 2 outputs alarm release notification to the credit control unit 1 as alarm information (Step St4), and ends the processing. The processing of the load monitoring unit 2 is executed in this manner.

When the scheduler unit 5 is configured by plural CPUs, the load monitoring unit 2 may execute the determination processing of Step St2 for each of the CPUs and output alarm occurrence notification when “load>Lth” is satisfied in any one of the CPUs. In addition, the load monitoring unit 2 may perform notification of alarm information classifying the alarm information into multiple levels according to the load as described below.

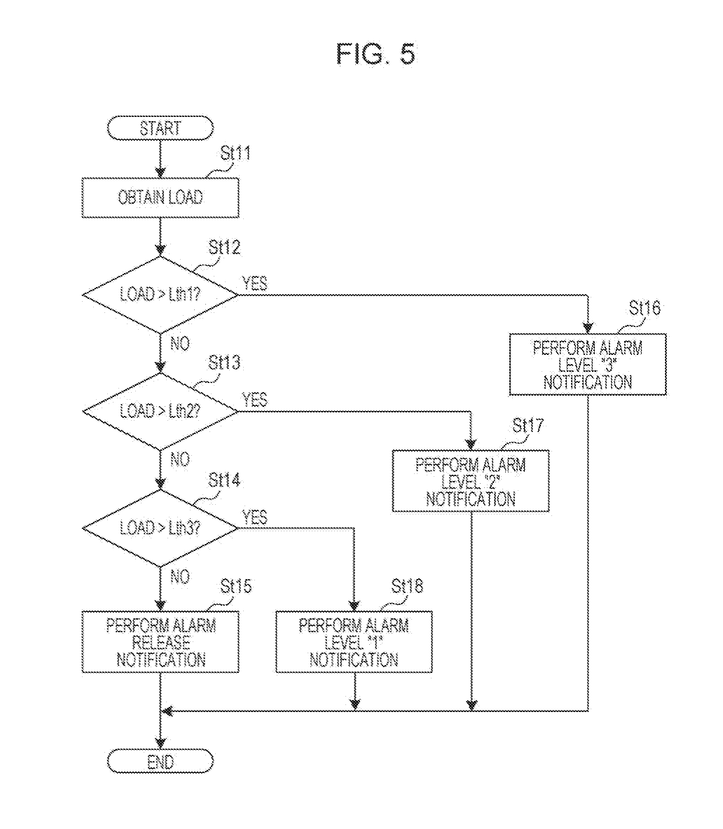

FIG. 5 is a flowchart illustrating a further example of the processing of the load monitoring unit 2. The processing is executed, for example, periodically.

First, the load monitoring unit 2 obtains a load in the processing of the scheduler unit 5 (Step St11). Next, the load monitoring unit 2 compares the obtained load with a threshold value Lth 1 (Step St12). The threshold value Lth 1 is, for example, 90(%).

When “load>Lth1” is satisfied (“YES” in Step St12), the load monitoring unit 2 outputs alarm level “3” notification to the credit control unit 1 as alarm information (Step St16), and ends the processing. In addition, when “load≦Lth1” is satisfied (“NO” in Step St12), the load monitoring unit 2 compares the obtained load with a threshold value Lth 2 (Step St13). The threshold value Lth 2 is, for example, 70(%).

When “load>Lth2” is satisfied (“YES” in Step St13), the load monitoring unit 2 outputs alarm level “2” notification to the credit control unit 1 as alarm information (Step St17), and ends the processing. In addition, when “load≦Lth2” is satisfied (“NO” in Step St13), the load monitoring unit 2 compares the obtained load with a threshold value Lth 3 (Step St14). The threshold value Lth 3 is, for example, 50(%).

When “load>Lth3” is satisfied (“YES” in Step St14), the load monitoring unit 2 outputs alarm level “1” notification to the credit control unit 1 as alarm information (Step St18), and ends the processing. In addition, when “load≦Lth3” is satisfied (“NO” in Step St14), the load monitoring unit 2 outputs alarm release notification to the credit control unit 1 as alarm information (Step St15), and ends the processing. The processing of the load monitoring unit 2 is executed in this manner.

As described above, due to the alarm information being divided into alarm levels “1” to “3” and notified, the credit control unit 1 is enabled to control the amount of credit to be supplied in accordance with the alarm levels “1” to “3”. For example, when a normal amount of credit supplied is assumed to be 10 (KByte), the credit control unit 1 may set the amount of credit supplied at 30 (KByte) in the case of the alarm level “1”, set the amount of credit supplied at 50 (KByte) in the case of the alarm level “2”, and set the amount of credit supplied at 100 (KByte) in the case of the alarm level “3”.

In this manner, when the credit control unit 1 controls the scheduler unit 5 so as to increase amount of credit supplied according to a load, amount of credit to be supplied is appropriately controlled according to a load. An operation of the credit control unit 1 is described below.

As described below, the credit control unit 1 controls supply of credit according to the type of flow for one of the flows #1 to #M selected to be supplied with credit such that the bandwidth is controlled in an equitable manner among the flows #1 to #M.

For example, when the bandwidth-guaranteed flow such as the flow #3 in FIG. 3 has been selected, the credit control unit 1 controls the scheduler unit 5 so that the amount of credit supply increases. Since the bandwidth of the bandwidth-guaranteed flow is controlled by the flow shaper 54, a certain credit amount corresponding to the guaranteed bandwidth is supplied as a whole even when the amount of credit supply is changed. Therefore, in the case of a bandwidth-guaranteed flow, even when the amount of credit supply is changed, there is no influence on the bandwidths of the other flows #1 to #M.

In addition, for example, when the non-bandwidth-guaranteed flow such as the flow #1 or #2 in FIG. 3 has been selected, the credit control unit 1 controls supply of credit according to the token amount of the port shaper 57. When a token amount of a port being selected by the port selection unit 59 is larger than a certain amount K, the credit control unit 1 controls the scheduler unit 5 so that the supply amount of credits increases.

The reason for this is that, given an excess token amount, there is no influence on the bandwidth of other flows within the flows #1 to #M because the sufficient bandwidth is allocated to the other flows within the flows #1 to #M corresponding to the same one of the ports #1 to #N even when the amount of credit supply is changed. With such control, the credit control unit 1 may reduce the load of processing at the scheduler unit 5 by increasing amount of credit supply even for non-bandwidth-guaranteed flows.

On the contrary, the credit control unit 1 does not increase the amount of credit supply when the token amount at the port being selected by the port selection unit 59 is the certain amount K or less. This is because, with no excess token amount, a change in credit supply creates inequity in bandwidth among the flows #1 to #M due to shortage in the bandwidth to be allocated to the other flows within the flows #1 to #M corresponding to the same one of ports #1 to #N.

However, in the above-described case, the credit control unit 1 instructs the scheduler unit 5 to execute processing in which the selection processing of the ports #1 to #N by the port selection unit 59 is skipped (hereinafter referred to as “skip processing”). More specifically, the credit control unit 1 controls the scheduler unit 5 so that credit are also supplied to the other flows within the flows #1 to #M corresponding to the port being selected before port selection by the port selection unit 59 is switched.

Thus, for each of the flows #1 to #M corresponding to one of the ports #1 to #N being selected, port selection is not performed, while credit is supplied. This thereby enables the scheduler unit 5 to skip selection of the ports #1 to #N by the number of corresponding flows, reducing the processing load.

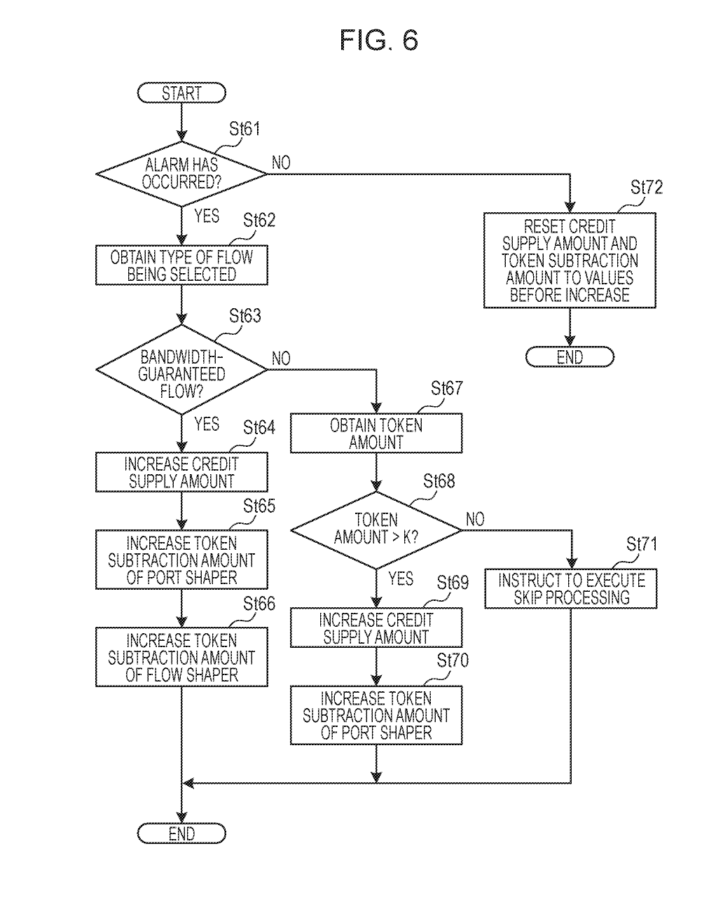

FIG. 6 is a flowchart illustrating an example of processing of the credit control unit 1. The processing is executed, for example, periodically.

First, the credit control unit 1 determines the presence or absence of occurrence of an alarm, based on alarm information from the load monitoring unit 2 (Step St61). When an alarm has occurred (“YES” in Step St61), the credit control unit 1 obtains the type of the flow #1 to #M being selected to be supplied with credit by the credit supply unit 52 (Step St62). More specifically, the credit control unit 1 obtains the flow ID of the flow that is being selected, from the port selection unit 59, and obtains the type of the flow by referring to the flow management table of the token management unit 53, based on the obtained flow ID.

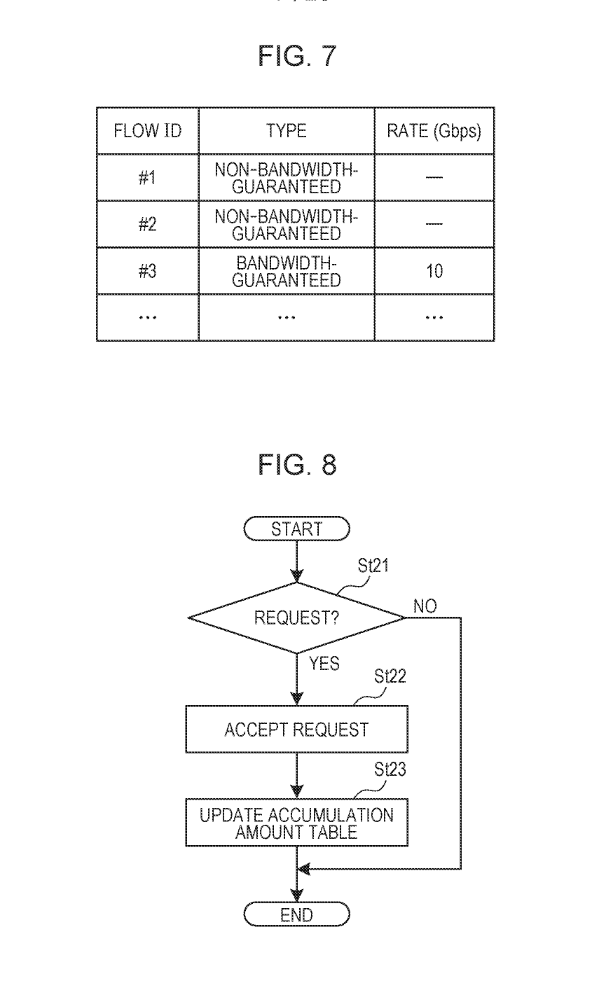

FIG. 7 illustrates an example of the flow management table. In the flow management table, the type (bandwidth-guaranteed or non-bandwidth-guaranteed) and the rate are registered for each of the flows. The rate is registered for only the bandwidth-guaranteed flow. The token management unit 53 supplies tokens to the flow shaper 54, based on the rate for the bandwidth-guaranteed flow.

Returning to FIG. 6, when the flow type is a bandwidth-guaranteed flow (“YES” in Step St63), the credit control unit 1 controls the scheduler unit 5 so that the amount of credit supply is increased by a fixed amount (Step St64). In performing this, the credit control unit 1 increases the amount of credit supply, for example, from 10 (KByte) to 100 (KByte).

In this manner, the credit control unit 1 controls the scheduler unit 5 so that the amount of credit supply is increased by a fixed amount when the load of the scheduler unit 5 exceeds a certain threshold value Lth. The rate at which the credit is supplied is suppressed according to the increase in the load, enabling the processing load of the scheduler unit 5 to be reduced.

Next, the credit control unit 1 controls the token management unit 53 so that the subtraction amount of tokens of the port shaper 58 is increased in accordance with the increase in the amount of credit supply, at the time credit is supplied (Step St65). In performing this, the credit control unit 1 increases the subtraction amount of the tokens, for example, from 10 (KByte) to 100 (KByte). Therefore, inconsistency in the management of the bandwidth in unit of port does not occur.

Next, the credit control unit 1 controls the token management unit 53 so that the subtraction amount of tokens of the flow shaper 54 is increased in accordance with the increase in the amount of credit supply, at the time credit is supplied (Step St66). In performing this, the credit control unit 1 increases the subtraction amount of the tokens, for example, from 10 (KByte) to 100 (KByte). Therefore, inconsistency in the management of the bandwidth of the bandwidth-guaranteed flow does not occur.

In addition, when the flow type is a non-bandwidth-guaranteed flow (best-effort flow) (“NO” in Step St63), the credit control unit 1 obtains the token amount of the port shaper 57 corresponding to the flow from the token management unit 53 (Step St67). Next, the credit control unit 1 compares the obtained token amount with a predetermined amount K (Step St68).

When “token amount>K” is satisfied (“YES” in Step St68), the credit control unit 1 controls the scheduler unit 5 so that the amount of credit supply increases by a fixed amount (Step St69). At this time, the credit control unit 1 increases the amount of the credit supply, for example, from 10 (KByte) to 100 (KByte).

Next, the credit control unit 1 controls the token management unit 53 so that the subtraction amount of tokens at the port shaper 57 increases at the time of credit supply according to an increase in the amount of credit supply (Step St70). At this time, the credit control unit 1 increases the subtraction amount of the tokens, for example, from 10 (KByte) to 100 (KByte). Therefore, inconsistency in the management of the bandwidth in unit of port does not occur.

As illustrated in the example of FIG. 5, when an alarm level out of the alarm levels “1” to “3” is notified as alarm information, the amount of credit supply after the increase in the above-described Steps St64 and St69 and the subtraction amount of the tokens after the increase in the above-described Steps St65, St66, and St70 change according to an alarm level.

When “token amount≦K” is satisfied (“NO” in Step St68), the credit control unit 1 instructs the scheduler unit 5 to execute the skip processing (Step St71). Accordingly, the credit supply unit 52 supplies credit to other flows within the flows #1 to #M corresponding to the same port as one of the flows #1 to #M being selected, without performing selection of the ports #1 to #N. This enables selection of the ports #1 to #N to be skipped by the same number of times as the number of the other flows to which credit is supplied, thereby enabling the load of processing by the scheduler unit 5 to be reduced.

In addition, in the determination processing of Step St61, when an alarm has not occurred (No in Step St61), the credit control unit 1 controls the scheduler unit 5 so that the values of the credit supply amount and the subtraction amount of the tokens are respectively reset to the values before the increase (Step St72). At this time, the credit control unit 1 resets the credit supply amount from 100 (KByte) to 10 (KByte), and resets the subtraction amount of the tokens from 100 (KByte) to 10 (KByte). Non-occurrence state of an alarm is determined by alarm release notification.

In this manner, when the load of the processing of the scheduler unit 5 is the threshold value Lth or less, the credit control unit 1 controls the scheduler unit 5 so that the credit supply amount is reset to the value before the increase. Thus, when the load of the processing of the scheduler unit 5 is reduced, the credit control unit 1 may reduce the burstiness of traffic by reducing the amount of the credit supply. The processing of the credit control unit 1 is executed in this manner.

The processing of the scheduler unit 5 is next described below.

FIG. 8 is a flowchart illustrating an example of processing of the request reception unit 50. The processing is executed, for example, periodically.

First, the request reception unit 50 determines the presence or absence of a request message from the queue management unit 4 (Step St21). As described later, the request message that has been received from the queue management unit 4 is stored in a buffer.

When there is no request message (“NO” in Step St21), the request reception unit 50 ends the processing. When there is a request message (“YES” in Step St21), the request reception unit 50 accepts the request (Step St22). At this time, the request reception unit 50 reads out the request message from the buffer. As described later, when the load of the processing of the scheduler unit 5 exceeds the threshold value Lth, the request reception unit 50 may accept plural request messages at a time.

Next, the request reception unit 50 updates the accumulation amount table 51 according to the content of the request message (Step St23). At this time, the request reception unit 50 adds the packet length stored in the request message to an accumulation amount of the corresponding one of flows #1 to #M in the accumulation amount table 51. The processing of the request reception unit 50 is executed in this manner.

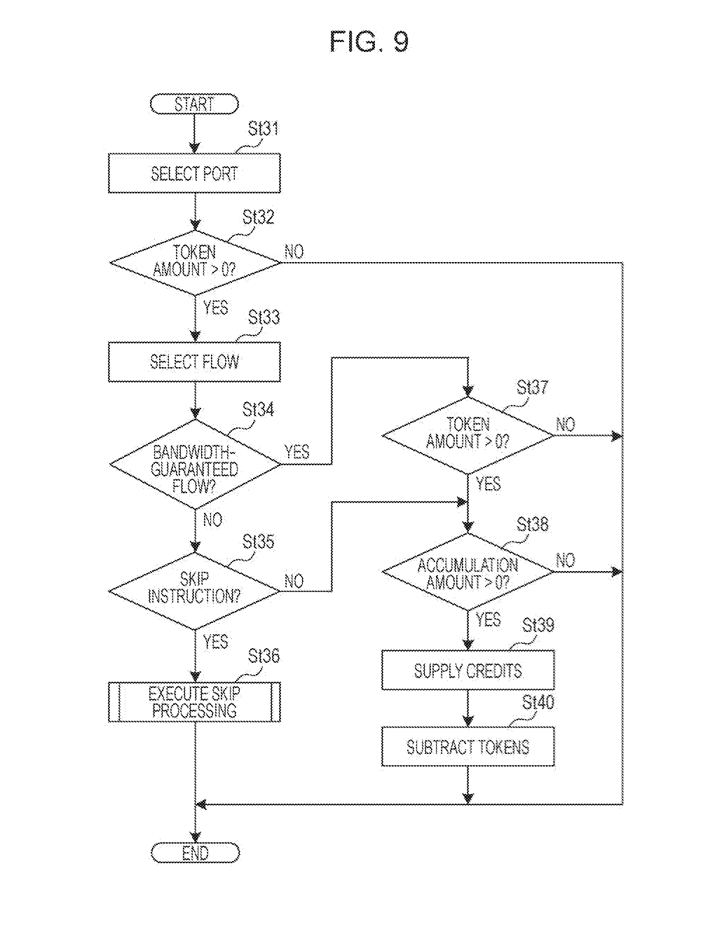

FIG. 9 is a flowchart illustrating an example of the scheduling processing. The processing is executed, for example, periodically, and the interval is changed according to the amount of credit supply.

First, the scheduler unit 5 selects one of ports #1 to #N via the port selection unit 59 (Step St31). More specifically, the port selection unit 59 selects the normal flow selection unit 55 or the priority flow selection unit 56 corresponding to the selected one of the ports #1 to #N.

Next, the scheduler unit 5 determines whether or not a token amount of the port shaper 57 corresponding to the one of the ports #1 to #N that has been selected by the port selection unit 59 is larger than 0 (Step St32). When “token amount≦0” is satisfied (“NO” in Step St32), the scheduler unit 5 ends the processing. When “token amount>0” is satisfied (“YES” in Step St32), the scheduler unit 5 selects one of flows #1 to #M either via the normal flow selection unit 55 or the priority flow selection unit 56 (Step St33).

When the selected one of the flows #1 to #M is a non-bandwidth-guaranteed flow (best-effort flow) (“NO” in Step St34), the scheduler unit 5 determines the presence or absence of an instruction for the skip processing from the credit control unit 1 (Step St35). When there is an instruction for the skip processing (“YES” in Step St35), the scheduler unit 5 executes the skip processing described later (Step St36). When there is no instruction for the skip processing (“NO” in Step St35), the scheduler unit 5 executes processing of Step St38 and subsequent steps described later.

In addition, when the selected one of the flows #1 to #M is a bandwidth-guaranteed flow (“YES” in Step St34), the scheduler unit 5 determines whether or not a token amount of the flow shaper 54 corresponding to the selected one of the flows #1 to #M is larger than 0 (Step St37). When “token amount≦0” is satisfied (“NO” in Step St37), the scheduler unit 5 ends the processing. In addition, when “token amount>0” is satisfied (“YES” in Step St37), the scheduler unit 5 supplies credits to the queue management unit 4 via the credit supply unit 52 (Step St39).

Next, the scheduler unit 5 performs subtraction of the token amount via the token management unit 53 (Step St40), and ends the processing. At this time, the scheduler unit 5 performs subtraction of the token amounts of the port shaper 58 and the flow shaper 54 when the selected one of the ports #1 to #N is a bandwidth-guaranteed flow, and performs subtraction of the token amount of the port shaper 57 when the selected one of the ports #1 to #N is a non-bandwidth-guaranteed flow. As described above, the scheduling processing is executed in this manner.

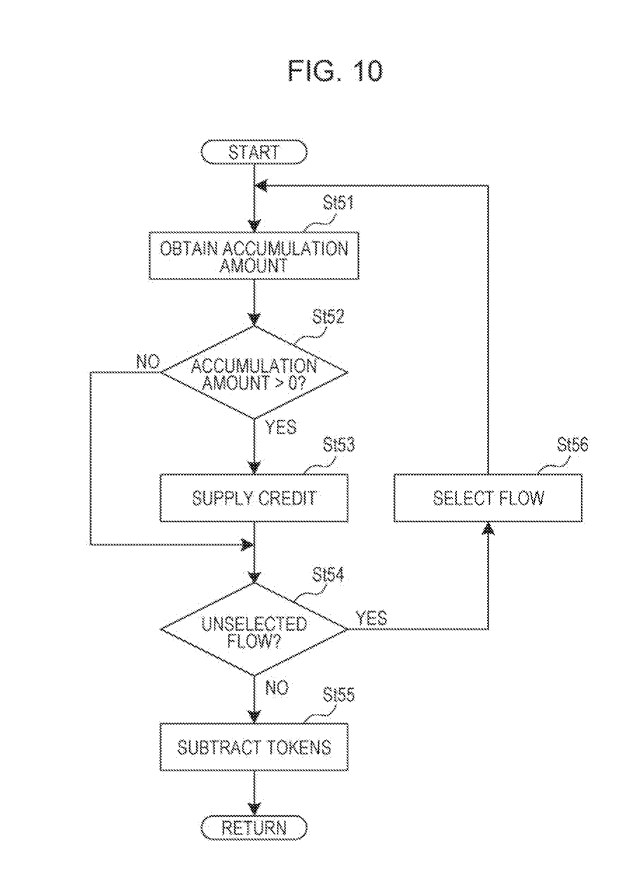

FIG. 10 is a flowchart illustrating an example of the skip processing. The processing corresponds to the processing of Step St36 in FIG. 9.

The scheduler unit 5 obtains an accumulation amount of one of the flows #1 to #M that has been selected, from the accumulation amount table 51 (Step St51). Next, the scheduler unit 5 determines whether or not the obtained accumulation amount is larger than 0 (Step St52).

When “accumulation amount>0” is satisfied (“YES” in Step St52), the scheduler unit 5 supplies credit to the queue management unit 4 via the credit supply unit 52. The supply amount of the credit at this time has not increased and remains at the original value. In addition, when “accumulation amount≦0” is satisfied (“NO” in Step St52), the scheduler unit 5 does not execute credit supply processing.

Next, the scheduler unit 5 determines the presence or absence of an unselected flow out of the other flows corresponding to the same one of the ports #1 to #N as the selected one of the flows #1 to #M (Step St54). When there is an unselected flow (“YES” in Step St54), the scheduler unit 5 selects one of the applicable flows (Step St56) and repeats the above-described processing of Steps St51 to St54.

Next, when there is no unselected flow left (“NO” in Step St54), the scheduler unit 5 subtracts the total amount of credit supplied in the processing of Step St53 from the token amount of the port shaper 57 (Step St55), and ends the processing. The skip processing is executed in this manner.

In the skip processing, the scheduler unit 5 supplies credit to each of flows within the flows #1 to #M corresponding to the same port without performing selection of the ports #1 to #N. Thus, the scheduler unit 5 may skip the selection processing of the ports #1 to #N by the same number of times as the number of flows to which the credit is supplied.

For example, in the case where the flows #1 to #10 correspond to the same port, when the credit supply unit 52 has selected the flow #1 that is the non-bandwidth-guaranteed flow to be supplied with credit, the credit supply unit 52 also supplies credit to the remaining flows #2 to #10. In this case, nine times worth of port selection processing, equal to the number of flows #2 to #10, have been skipped. This thereby enables the load of processing by the scheduler unit 5 to be reduced.

An example of the credit supply operation is described below.

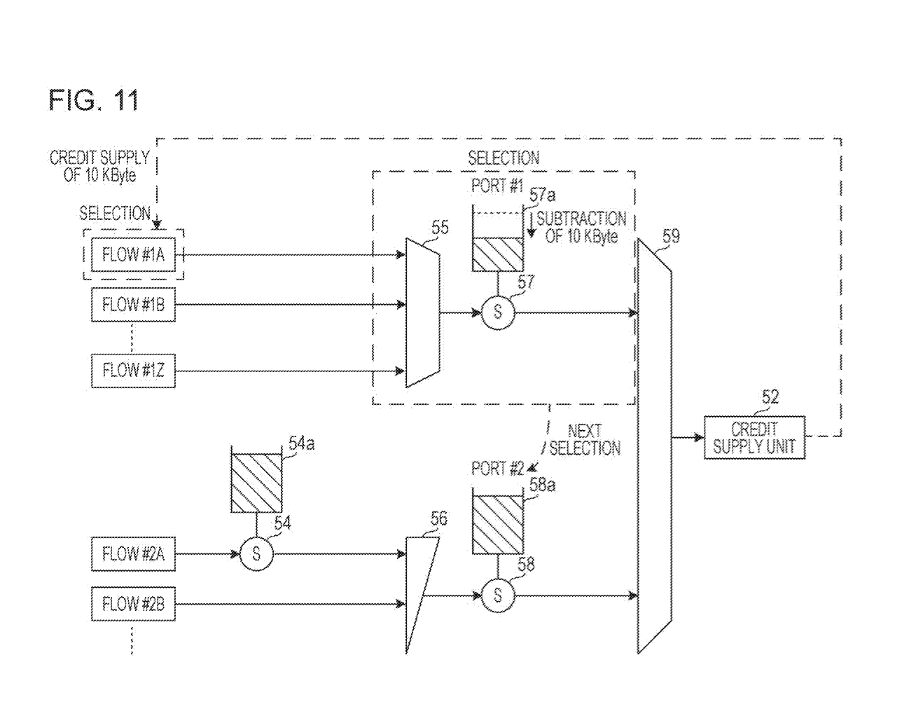

FIG. 11 illustrates an example of an operation of credit supply to a non-bandwidth-guaranteed flow during low load (load<Lth). In FIG. 11, the same symbols are applied to a configuration similar to FIG. 3, and the description thereof is omitted. In addition, a symbol 54a indicates a token bucket of the flow shaper 54, and symbols 57a and 58a indicate token buckets of the port shapers 57 and 58.

In this example, flows #1A to #1Z correspond to a port #1, and flows #2A, #2B, . . . correspond to a port #2. The flows #1A to #1Z and the flow #2B are non-bandwidth-guaranteed flows, and the flow #2A is a bandwidth-guaranteed flow. In this example, an operation when the credit supply unit 52 has selected a non-bandwidth-guaranteed flow is described.

The credit supply unit 52 selects the port #1, further selects the flow #1A corresponding to the port #1, and supplies credit of 10 (KByte) to the flow #1A (see the dotted line in FIG. 11). At this time, a token amount of 10 (KByte) is subtracted from a token bucket 57a of the port shaper 57. The credit supply unit 52 selects the port #2 after the selection of the port #1 (see “next selection” in FIG. 11).

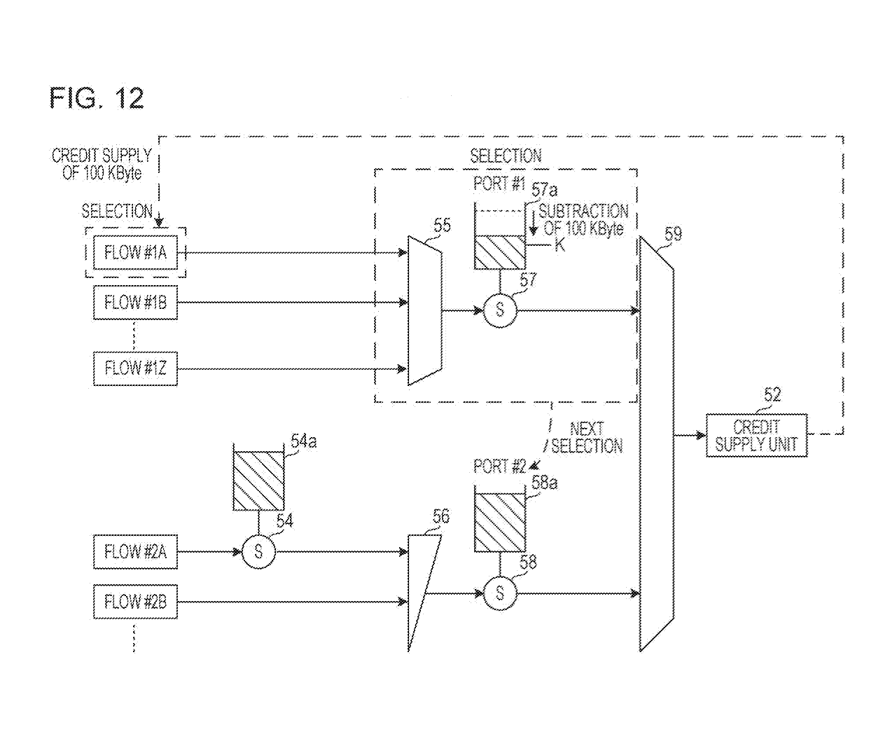

In addition, FIG. 12 illustrates an example of an operation of credit supply to a non-bandwidth-guaranteed flow during high load (load≧Lth). In FIG. 12, the same symbols are appended to a configuration similar to FIG. 11, and the description thereof is omitted. In this example, the operation in which the processing of Steps St69 and St70 in FIG. 6 has been executed is described.

The credit supply unit 52 selects the port #1 and further selects the flow #1A corresponding to the port #1. The credit supply unit 52 supplies credit of 100 (KByte) to the selected flow #1A because a token amount of the token bucket 57a of the port shaper 57 corresponding to the flow #1A is greater than a predetermined amount K (see the dotted line in FIG. 12). When this is performed, a token amount of 100 (KByte) is subtracted from the token bucket 57a of the port shaper 57 so that inconsistency in the management of the bandwidth does not occur. The credit supply unit 52 selects the port #2 after the selection of the port #1 (see “next selection” in FIG. 12).

In this example, since the credit ten times the credit during low load (=100 (KByte)/10 (KByte)) are supplied to the flow #1A, the performance of the scheduling processing is maintained, for example, even when it takes ten times the regular time for the selection of the next port #2.

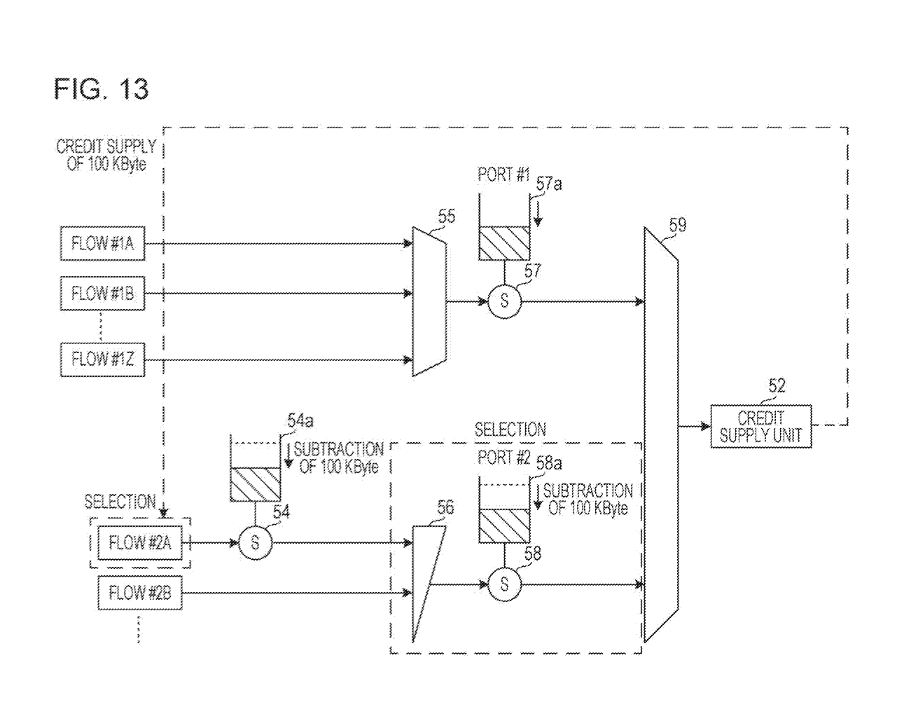

FIG. 13 illustrates an example of an operation of credit supply to a bandwidth-guaranteed flow during high load. In FIG. 13, the same symbol is applied to a configuration similar to FIG. 11, and the description is omitted herein. In this example, an operation in which the processing of Steps St64 to St66 in FIG. 6 has been executed is described.

The credit supply unit 52 selects the port #2 after the above-described operation and selects the flow #2A corresponding to the port #2. Since the flow #2A is a bandwidth-guaranteed flow, the credit supply unit 52 supplies credit of 100 (KByte) to the flow #2A regardless of a token amount of a token bucket 58a of the port shaper 58 or a token amount of a token bucket 54a of the flow shaper 54 corresponding to the selected flow #2A (see the dotted line in FIG. 13). When this is performed, a token amount of 100 (KByte) is subtracted from the token bucket 58a of the port shaper 58 and the token bucket 54a of the flow shaper 54 so that inconsistency in the management of the bandwidth does not occur.

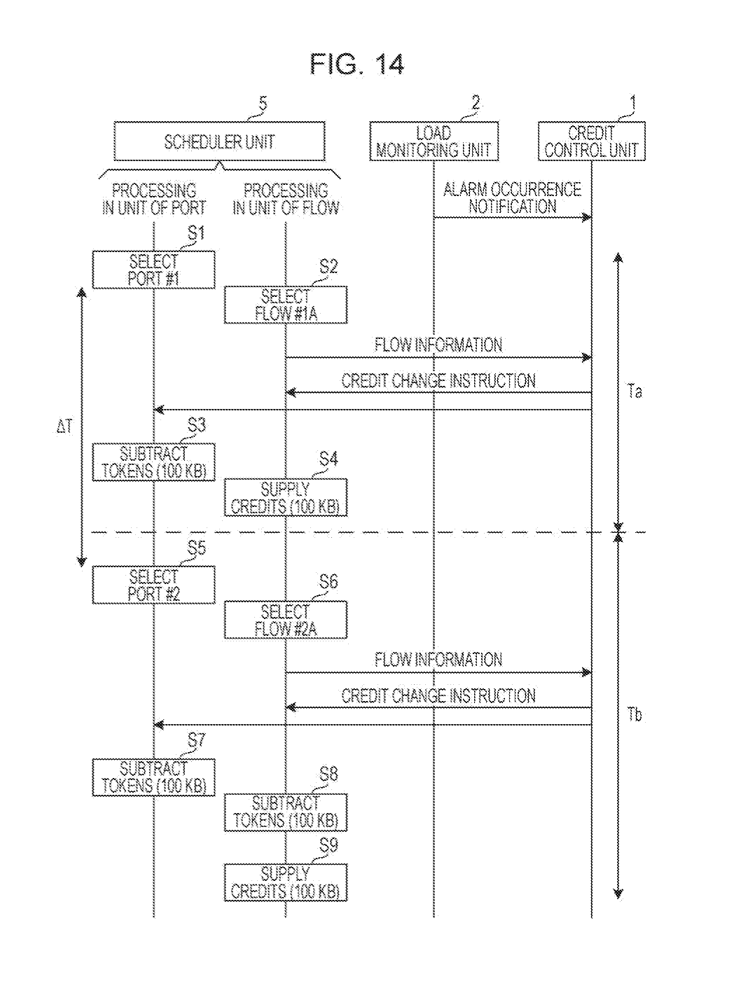

FIG. 14 is a sequence diagram illustrating an example of an operation of credit supply to a non-bandwidth-guaranteed flow and a bandwidth-guaranteed flow during high load. In FIG. 14, the processing of the scheduler unit 5 is illustrated so as to be divided into processing in a unit of a port and processing in a unit of a flow. A symbol Ta indicates a sequence of the operation illustrated in FIG. 12 and a symbol Tb indicates a sequence of the operation illustrated in FIG. 13.

The load monitoring unit 2 outputs alarm occurrence notification to the credit control unit 1. Next, the scheduler unit 5 selects the port #1 (see the symbol S1 in FIG. 14), and selects the flow #1A (see the symbol S2 in FIG. 14). Next, the scheduler unit 5 notifies the credit control unit 1 of flow information including the flow type and a token amount of the port shaper 57.

The credit control unit 1 determines that the flow type is a non-bandwidth-guaranteed flow and “token amount>K” is satisfied, based on the flow information, and the credit control unit 1 outputs a credit change instruction instructing the scheduler unit 5 to change the credit supply amount and a subtraction amount of tokens to 100 (KByte). The scheduler unit 5 subtracts 100 (KByte) from the token amount of the port shaper 57 in response to the credit change instruction (see the symbol S3 in FIG. 14), and supplies credit of 100 (KByte) to the flow #1A (see the symbol S4 in FIG. 14).

Next, the scheduler unit 5 selects the port #2 (see the symbol S5 in FIG. 14) and selects the flow #2A (see the symbol S6 in FIG. 14). Next, the scheduler unit 5 notifies the credit control unit 1 of flow information including the flow type.

The credit control unit 1 determines that the flow type is a bandwidth-guaranteed flow, based on the flow information, so that the credit control unit 1 outputs a credit change instruction instructing the scheduler unit 5 to change the credit supply amount and the subtraction amount of tokens to 100 (KByte). The scheduler unit 5 subtracts 100 (KByte) from the token amount of the port shaper 58 in response to the credit change instruction (see the symbol S7 in FIG. 14), and subtracts 100 (KByte) from the token amount of the flow shaper 54 (see the symbol S8 in FIG. 14). In addition, the scheduler unit 5 supplies credit of 100 (KByte) to the flow #2A (see the symbol S9 in FIG. 14).

As described above, in this example, credit that is ten times the credit during low load is supplied to the flow #1A, so that the performance of the scheduling processing is maintained, for example, even when it takes time ΔT that is ten times the regular time for the selection of the next port #2.

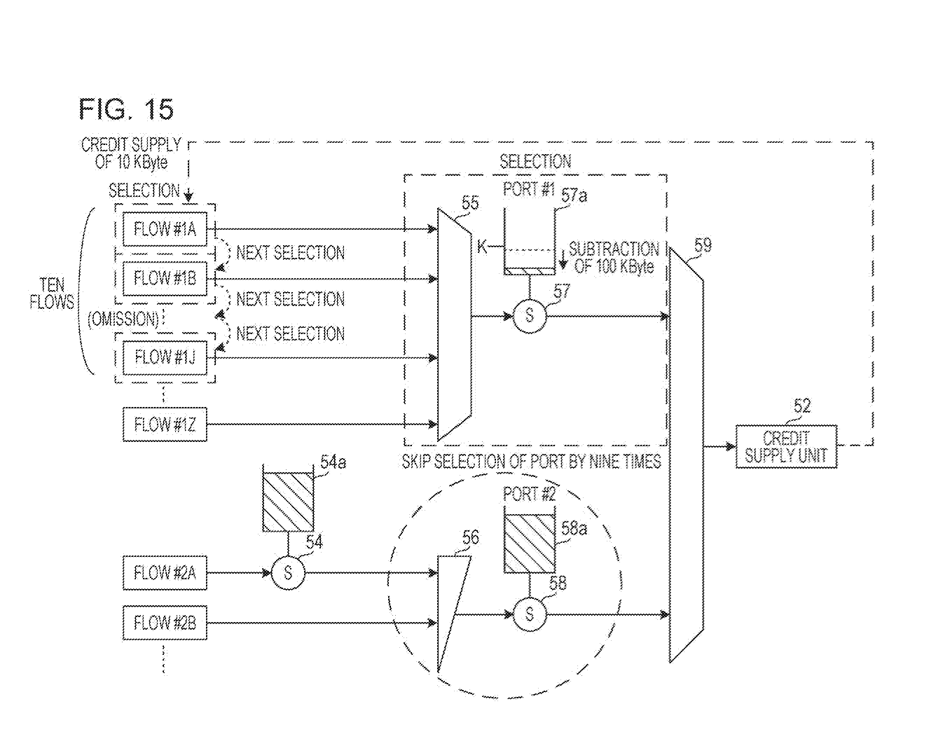

FIG. 15 illustrates a further example of the operation of credit supply to the non-bandwidth-guaranteed flow during high load. In FIG. 15, the same symbol is applied to a configuration similar to FIG. 11, and the description thereof is omitted. In this example, an operation when the processing of Step St71 in FIG. 6 has been executed is described.

In this example, it is assumed that, in the accumulation amount table 51, out of the flows #1A to #1Z corresponding to the port #1, respective accumulation amount is larger than 0 only for the flows #1A to #1J. In other words, only the flows #1A to #1J request credit.

The credit supply unit 52 selects the port #1 and further selects the flow #1A corresponding to the port #1. The credit supply unit 52 supplies credit of 10 (KByte) to the flow #1A (see the dotted line in FIG. 15) because a token amount of the token bucket 57a of the port shaper 57 corresponding to the selected flow #1A is smaller than the predetermined amount K. Namely, the amount of credit supplied dose not increase.

Next, the credit supply unit 52 sequentially selects the ten flows #1B, #1C, . . . , and #1J and supplies credit of 10 (KByte) to each of the flows (see “next selection” in FIG. 15). At this time, the token amount of 100 (KByte) that is the total supply amount of the credits of the ten flows #1A, #1B, . . . , and #1J is subtracted from the token bucket 57a of the port shaper 57 so that inconsistency in the management of the bandwidth does not occur.

In this manner, the credit control unit 1 supplies credits to the ten flows #1A, #1B, . . . , and #1J in a single port selection. This amounts to 9 port selections skipped, since the credit control unit 1, during low load, supplies credit to one flow out of the flows #1 to #M in a single port selection. This thereby enables the load of processing by the scheduler unit 5 to be reduced

FIG. 16 is a sequence diagram illustrating the further example of the operation of credit supply to the non-bandwidth-guaranteed flow and bandwidth-guaranteed flow during high load. The sequence corresponds to the operation example illustrated in FIG. 15.

The load monitoring unit 2 outputs alarm occurrence notification to the credit control unit 1. Next, the scheduler unit 5 selects the port #1 (see the symbol S11 in FIG. 16) and selects the flow #1A (see the symbol S12 in FIG. 16). Next, the scheduler unit 5 notifies the credit control unit 1 of flow information including the flow type and a token amount of the port shaper 57.

The credit control unit 1 determines that the flow type is a non-bandwidth-guaranteed flow and “token amount≦K” is satisfied, based on the flow information, so that the credit control unit 1 outputs a skip processing instruction to the scheduler unit 5. The scheduler unit 5 subtracts 100 (KByte) that is the total amount of the credit supply from the token amount of the port shaper 57, in response to the skip processing instruction (see the symbol S13). In addition, the scheduler unit 5 supplies credit of 10 (KByte) to the flow #1A (see the symbol S14 in FIG. 16).

Next, the scheduler unit 5 selects the flow #1B (see the symbol S15 in FIG. 16) and supplies credit of 10 (KByte) to the flow #1B (see the symbol S16). And then, the scheduler unit 5 sequentially selects the flows #1C to #1I, supplies credit of 10 (KByte), and as the last selection, selects the flow #1J (see the symbol S17 in FIG. 16) supplying credit of 10 (KByte) to the flow #1J (see the symbol S18 in FIG. 16).

Nine port selections have been skipped in this manner, thereby enabling the load of processing by the scheduler unit 5 to be reduced.

Note that, for example, when all of the flows #1 to #M are non-bandwidth-guaranteed flows, the credit supply amount may be increased in one operation for all of the flows #1 to #M as described below. In this case, time taken to change the amount of credit supply is prolonged, alarm is stopped hallway through the change, and this may cause inequity among flows #1 to #M with some of the flow in a state of increased credit while being rolled back. In order to avoid such a situation, as described below, a certain wait period may be provided until the amount of credit supply is reset to the original value.

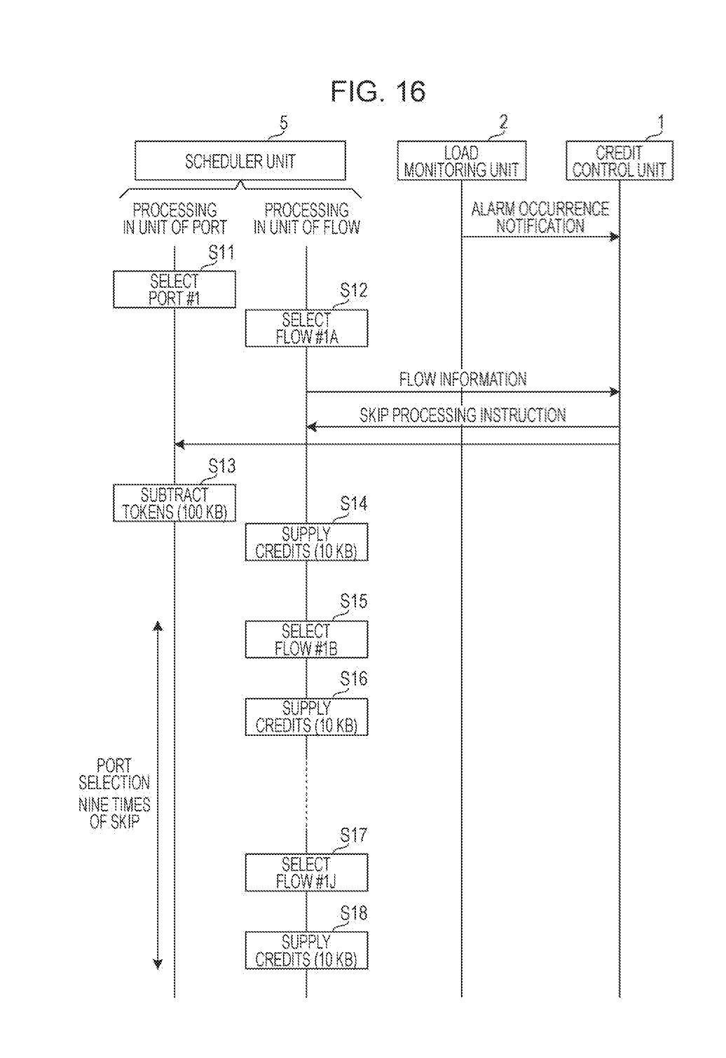

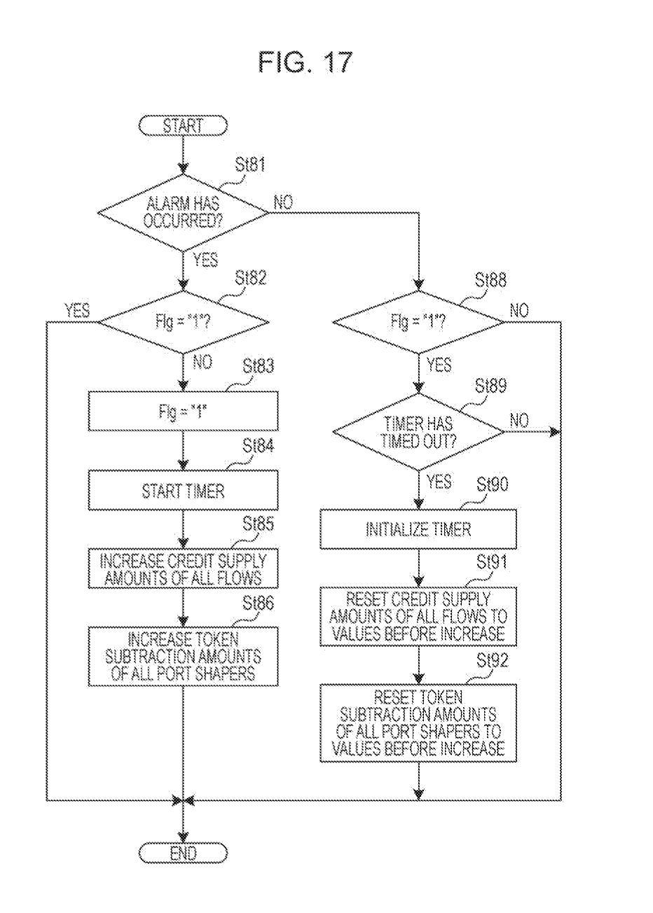

FIG. 17 is a flowchart illustrating an example of processing of the credit control unit 1 according to another embodiment. The processing is executed, for example, periodically.

First, the credit control unit 1 determines the presence or absence of occurrence of an alarm (Step St81). In this case, the presence or absence of occurrence of an alarm is determined based on alarm information from the load monitoring unit 2.

Next, the credit control unit 1 determines whether or not a change flag Flg is “1” (Step St82). The change flag Flg “0” indicates a change in the amount of credit supply, and the change flag Flg “1” indicates that there is no change in the amount of credit supply.

When the change flag Flg is “1” (“YES” in Step St82), the credit control unit 1 ends the processing. When the change flag Flg is “0” (“NO” in Step St82), the credit control unit 1 sets “change flag Flg=1” (Step St83). Next, the credit control unit 1 causes a timer to start in order to measure a standby time to reset the amount of credit supplied to the original value (Step St84).

Next, the credit control unit 1 controls the scheduler unit 5 so that the amount of credit supplied increases by a fixed amount for all of the flows #1 to #M (Step St85). Next, the credit control unit 1 controls the scheduler unit 5 so that the subtraction amount of the tokens increases by a fixed amount for all of the port shapers 57 and 58 (Step St86), and ends the processing.

In addition, the credit control unit 1 determines whether or not the change flag Flg is “1” (Step St88) when an alarm has not occurred (“NO” in Step St81). When the change flag Flg is “0” (“NO” in Step St88), the credit control unit 1 ends the processing. When the change flag Flg is “1” (“YES” in Step St88), the credit control unit 1 determines whether or not the timer has timed out (Step St89). Time until the timer times out, namely the standby time, is set such that it is the sufficient time in which the amount of credit supply for all of the flows #1 to #M may be changed.

When the timer has not timed out (“NO” in Step St89), the credit control unit 1 ends the processing. When the timer has timed out (“YES” in Step St89), the credit control unit 1 initializes the timer (Step St90).

Next, the credit control unit 1 controls the scheduler unit 5 so that the amount of credit supply is restored to the value before the increase for all of the flows #1 to #M (Step St91). Next, the credit control unit 1 controls the scheduler unit 5 so that the subtraction amount of the tokens is restored to the value before the increase for all of the port shapers 57 and 58 (Step St92), and ends the processing. The processing of the credit control unit 1 is executed in this manner.

In addition, the credit control unit 1 may reduce the load of the processing of the scheduler unit 5 by extending the supply interval of tokens from the token management unit 53 to the port shapers 57 and 58. In this case, the credit control unit 1 controls the port management table of the token management unit 53.

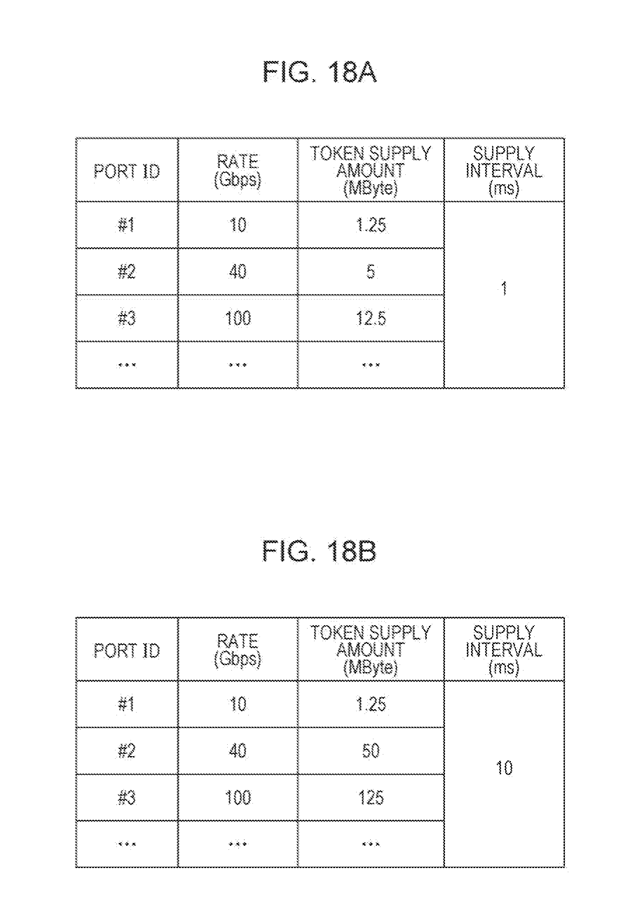

FIG. 18A illustrates an example of the port management table during low load, and FIG. 18B illustrates an example of the port management table during high load. The low load indicates a state in which “load of the processing of the scheduler unit 5≦Lth” is satisfied, and the high load indicates a state in which “load of the processing of the scheduler unit 5>Lth” is satisfied. Note that when the processing of the load monitoring unit 2 illustrated in FIG. 5 is executed, for example, the low load indicates a state in which “load of the processing of the scheduler unit 5≦Lth1” is satisfied, and the high load indicates a state in which “load of the processing of the scheduler unit 5>Lth1” is satisfied.

In the port management table, a rate (Gbps), a token supply amount (MByte), and a supply interval (ms) are registered for each of the ports. For example, the token management unit 53 supplies to the port shaper 57, corresponding to the port #1, tokens of 1.25 (MByte) at the interval of 1 (ms) during low load, but supplies tokens of 12.5 (MByte) at the interval of 10 (ms) during high load.

Further, the token management unit 53, for example, to the port shaper 58 corresponding to the port #2, supplies tokens of 5 (MByte) at the interval of 1 (ms) during low load, but supplies tokens of 50 (MByte) at the interval of 10 (ms) during high load. That is, during high load, the token management unit 53 extends the supply interval to a supply interval ten times that of the low load, and increases the token supply amount to a token supply amount ten times that of the low load. In this example, the control of the port shapers 57 and 58 are described, but similar control may be performed for the flow shaper 54.

In this manner, the credit control unit 1 may reduce the load of the processing of the scheduler unit 5 by controlling the scheduler unit 5 so that the allocation interval of tokens to the ports #1 to #N is extended. In a case in which the scheduler unit 5 is realized by software on plural CPUs, the above-described control may be performed only when a CPU that executes token supply processing of the port shapers 57 and 58 is in the state of high load.

In addition, in order to reduce the load of processing, the scheduler unit 5 may accept request messages from the PKT distribution unit 40 in batches by the priority level instead of accepting the request messages individually, and supply credit in accordance with the accepted requests. In this case, for example, as described later, the request reception unit 50 of the scheduler unit 5 may control an acceptance interval of a request message according to the load that has been obtained by the load monitoring unit 2.

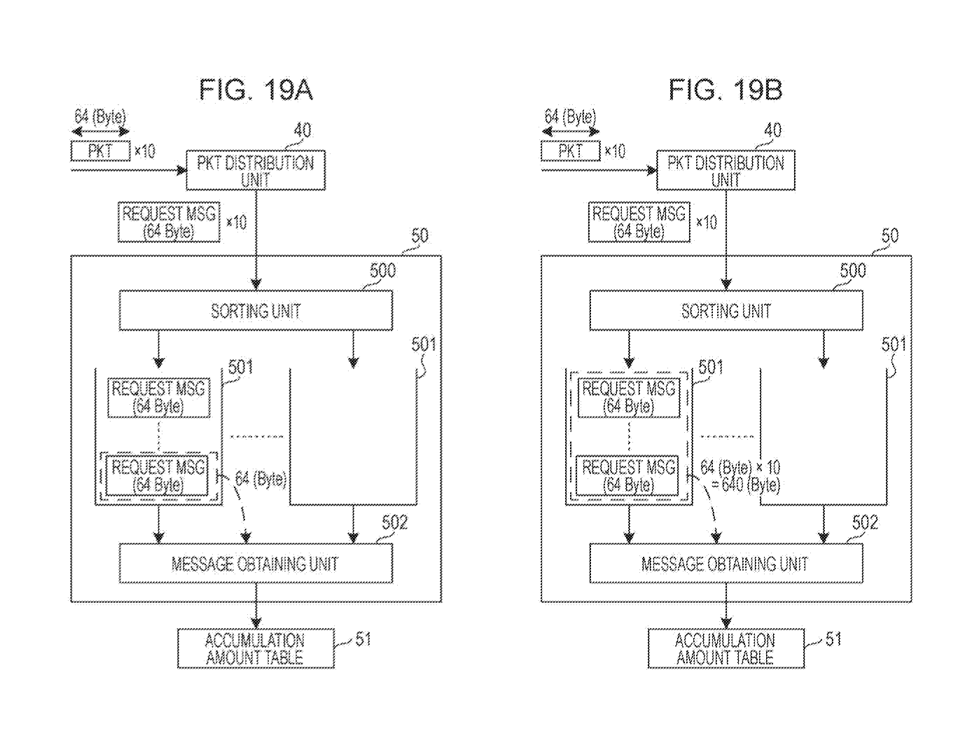

FIG. 19A illustrates an example of an operation of the request reception unit 50 during low load (load≦Lth), and FIG. 19B illustrates an example of an operation of the request reception unit 50 during high load (load>Lth). In these examples, ten packets (PKT) each having the 64 (Byte) length are input to the PKT distribution unit 40, and the PKT distribution unit 40 outputs ten request messages (MSG) each requesting a credit of 64 (Byte), to the request reception unit 50.

The request reception unit 50 includes a sorting unit 500, buffers 501 respectively provided to the flows #1 to #M, and a message obtaining unit 502. The sorting unit 500 identifies a flow ID of the request message that has been input from the PKT distribution unit 40 and inputs the request message to a buffer 501 corresponding to the flow ID. The buffer 501 stores the request message that has been input from the sorting unit 500.

The message obtaining unit 502 sequentially selects the buffers 501 at certain intervals and obtains the request message from the selected buffer 501. The message obtaining unit 502 reads the packet length, that is, a request amount of a credit (64 (Byte) in this example), from the obtained request message, and adds the request amount to the accumulation amount of the corresponding flow ID in the accumulation amount table 51.

As illustrated in FIG. 19A, when “load≦Lth” is satisfied, the message obtaining unit 502 obtains a request message individually by selecting the buffer 501 at a high frequency (see the dotted line in FIG. 19A). In addition, as illustrated in FIG. 19B, when “load>Lth” is satisfied, the message obtaining unit 502 obtains ten request messages in a batch by selecting the buffer 501 at a low frequency (see the dotted line in FIG. 19A). At this time, the message obtaining unit 502 accepts the ten request messages as a request of credit of 640 (Byte) (=64×10). As a result, the message obtaining unit 502 may accept plural request messages in batches during high load.

Thus, the message obtaining unit 502 may reduce update frequency of the accumulation amount table 51 and reduce the load of processing of the scheduler unit 5. The message obtaining unit 502 may determine a load based on the alarm information from the load monitoring unit 2 (see the dotted line in FIG. 3). In addition, in a case in which the scheduler unit 5 is realized by software on plural CPUs, the above-described control may be performed only when a CPU that executes reception processing of the request message is in the state of high load. In addition, for example, in a case in which the load monitoring unit 2 executes the processing as illustrated in FIG. 5, the request reception unit 50 may perform the control as illustrated in FIG. 19A when “load≦Lth1” is satisfied, and may perform the control as illustrated in FIG. 19B when “load>Lth1” is satisfied.

In addition, in the above-described case, in the request reception unit 50, during high load, the reception processing of a request message is delayed compared to under low load. Therefore, the request reception unit 50 may accept requests in batches in accordance with the priority level corresponding to the total credit amount that has been requested by the request messages. That is, the request reception unit 50 may execute priority control processing of the request messages by providing a high priority buffer and a low priority buffer in addition to the above-described buffer 501.

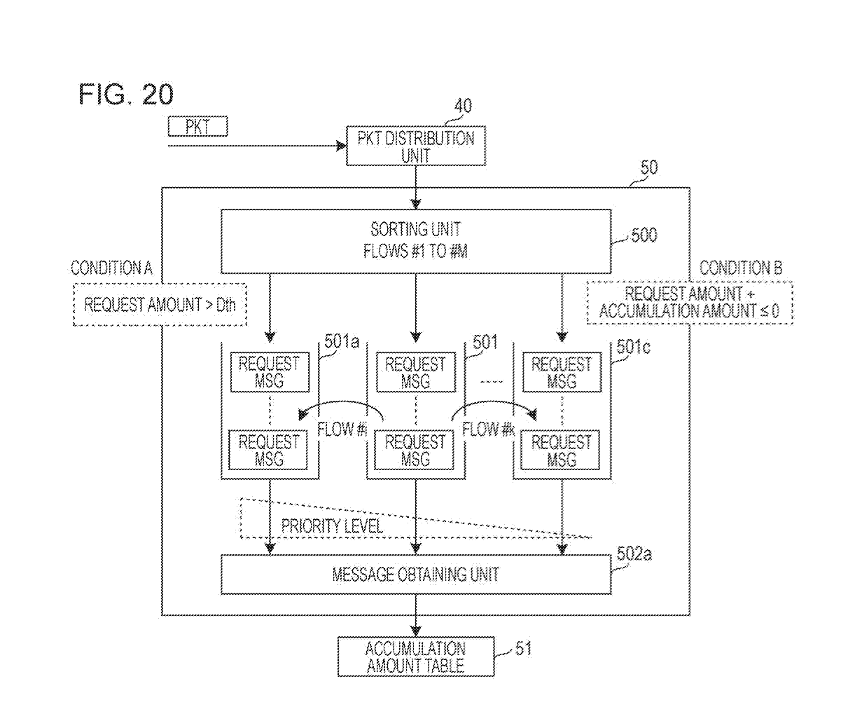

FIG. 20 illustrates an example of the priority control processing of a request message. In FIG. 20, the same symbol is applied to a configuration similar to FIGS. 19A and 19B, and the description thereof is omitted.

In this example, the request reception unit 50 includes the above-described buffers 501 respectively for the flows #1 to #M, a high priority buffer 501a having the highest priority level, and a low priority buffer 501c having the lowest priority level, as an example. The priority level of the buffer 501 corresponds to an intermediate level between the high priority buffer 501a and the low priority buffer 501c, and a request message is transferred to the high priority buffer 501a or the low priority buffer 501c when the request message satisfies a certain condition after the request message has been temporarily stored in the buffer 501.

A message obtaining unit 502a calculates the total request amount of credit of the request messages in each of the buffers 501 and performs priority control based on the total request amount (see “priority level” in FIG. 20). For example, when the input rate of a flow #i is high, and the total request amount of credit of the request messages in the buffer 501 of the flow #i exceeds a predetermined threshold value Dth (see “condition A” in FIG. 20), the sorting unit 500 transfers all of the request messages in the buffer 501 of the flow #i to the high priority buffer 501a. The message obtaining unit 502 preferentially selects the high priority buffer 501a and accepts the request messages so that credit is supplied in time for the processing of packets.

In addition, for example, it is assumed that, in a flow #k, the accumulation amount of the accumulation amount table 51 is a negative value because supply of credit has been performed just before output of a request message. At this time, when a combination value of the total request amount of credit of request messages in the buffer 501 of the flow #k and the accumulation amount of the accumulation amount table 51 is 0 or less (see “condition B” in FIG. 20), the sorting unit 500 transfers all of the request messages in the buffer 501 of the flow #k to the low priority buffer 501c. The message obtaining unit 502 selects the low priority buffer 501c at the lowest priority and accepts the request messages. This is because, when the condition B is satisfied, “accumulation amount≦0” is also satisfied, making the flow #k unable to be supplied with credit. The request messages in the flows #1 to #M by which any one of the above-described condition A and condition B is not satisfied stay in the buffer 501 of the intermediate priority level without being transferred to the high priority buffer 501a or the low priority buffer 501c.

The above-described bandwidth control device is provided with a single communication device, but the embodiment is not limited thereto. For example, the queue management unit 4 is implemented in the communication device that includes a memory and a processor coupled to the memory, and the load monitoring unit 2, the credit control unit 1, and the scheduler unit 5 may be implemented in a network management device including a processor, which manages the communication devices. A bandwidth control system that includes a communication device and a network management device is described below.

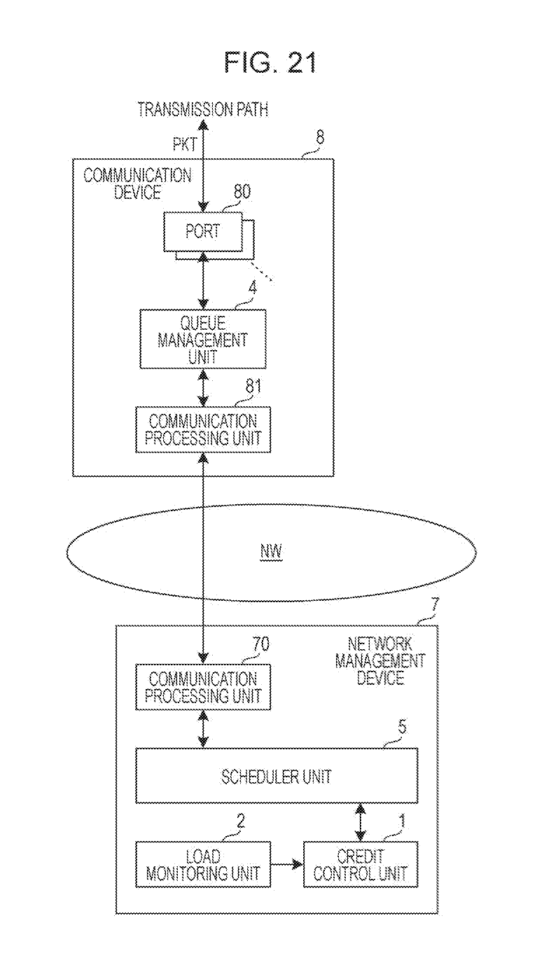

FIG. 21 is a configuration diagram illustrating an example of the bandwidth control system. The bandwidth control system includes a network management device 7 and a communication device 8 that communicate with each other through a network NW. The communication device 8 is an example of a first processing device, and the network management device 7 is an example of a second processing device.

The communication device 8 includes plural ports 80, the queue management unit 4, and a communication processing unit 81. Each of the plural ports 80 transmits and receives packets (PKT) to and from a transmission path.

The queue management unit 4 communicates with the network management device 7 through the communication processing unit 81 and performs the above-described bandwidth control. More specifically, the queue management unit 4 requests the network management device 7 for credit, receives supply of the credit from the network management device 7, reads packets from the queue 41 based on the credit, and outputs the packets to the port 80.

The network management device 7 includes a communication processing unit 70, the scheduler unit 5, the credit control unit 1, and the load monitoring unit 2. The communication processing unit 70 communicates with the queue management unit 4 through the communication processing unit 81 and performs the above-described bandwidth control. More specifically, the scheduler unit 5 supplies credit in response to a request from the queue management unit 4. The operations of the credit control unit 1 and the load monitoring unit 2 are also performed as described above.

As described above, the bandwidth control device according to embodiment includes the plural queues 41, the reading processing unit 42, the scheduler unit 5, and the credit control unit 1. The plural queues 41 respectively stores packets for the flows #1 to #M. The reading processing unit 42 reads packets from each of the plural queues 41, based on the credit supplied to each of the flows #1 to #M, and outputs the packets to one of the ports #1 to #N corresponding to each of the flows #1 to #M.

The scheduler unit 5 sequentially selects a port from the ports #1 to #N in this order, selects one of the flows #1 to #M corresponding to the selected port each time the port is selected, and supplies credit to the selected one of the flows #1 to #M.

When the flow that has been selected by the scheduler unit 5 is a bandwidth-guaranteed flow, the credit control unit 1 controls the scheduler unit 5 so that the credit supplied by the scheduler unit 5 increases. In addition, when the flow that has been selected by the scheduler unit 5 is a non-bandwidth-guaranteed flow, the credit control unit 1 controls the scheduler unit 5 so that credit is also supplied to other flows corresponding to the port that is being selected before the selection of a port from the ports #1 to #N is switched.

In the above-described configuration, when a bandwidth-guaranteed flow has been selected by the scheduler unit 5, amount of credit supply increases, so that the load of the processing of the scheduler unit 5 is reduced. In addition, when non-bandwidth-guaranteed flows have been selected by the scheduler unit 5, supply of credit is performed without selection of a port for the flows corresponding to the port being selected, so that the load of the processing of the scheduler unit 5 is reduced due to the skip of selection of a port.

In this manner, the credit control unit 1 controls supply of credit according to types of the flows #1 to #M that have been selected as a flow to be supplied with credit so that the bandwidth control does not become inequitable among the flows #1 to #M. Thus, in the bandwidth control device according to the embodiment, the load of the bandwidth control processing may be reduced without loss of equity of the bandwidth control among the flows #1 to #M.

In addition, the bandwidth control system according to the embodiment includes the communication device 8 and the network management device 7 that communicate with each other through the network NW. The communication device 8 includes the plural queues 41 and the reading processing unit 42. The network management device 7 includes the scheduler unit 5 and the credit control unit 1.

The plural queues 41 each store packets in different one of the flows #1 to #M. The reading processing unit 42 reads packets from each of the plural queues 41 based on a credit supplied to the corresponding one of flows #1 to #M, and outputs the packets to one of ports #1 to #N corresponding to the corresponding one of the flow #1 to #M.

The scheduler unit 5 sequentially selects a port from the ports #1 to #N, selects a flow corresponding to the port that is being selected, out of the flows #1 to #M, each time the port is selected, and supplies credit to the selected flow.

When the flow that has been selected by the scheduler unit 5 is a bandwidth-guaranteed flow, the credit control unit 1 controls the scheduler unit 5 so that credit supplied by the scheduler unit 5 increases. In addition, when the flow that has been selected by the scheduler unit 5 is a non-bandwidth-guaranteed flow, the credit control unit 1 controls the scheduler unit 5 so that credit are also supplied to other flows corresponding to the port that is being selected before the selection of a port from the ports #1 to #N is switched.

The bandwidth control system according to the embodiment includes a configuration similar to that of the above-described bandwidth control device, so that an operation effect similar to that of the above-described content is obtained.

The above-described embodiments are preferred examples of the technology discussed herein. However, the embodiments are not limited to such examples, and various modifications may be implemented within the scope not departing from the gist of the technology discussed herein.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A bandwidth control device comprising:
a memory including a plurality of queues each configured to store packets for different one of a plurality of flows; and
a processor coupled to the memory and configured to:
read out packets from each of the plurality of queues according to an allowable readout amount supplied for a flow corresponding to the each queue, and output the packets to one of ports corresponding to the flow, the allowable readout amount being an amount of data for packets that are allowed to be read out at one time from a queue, and
execute a readout amount supply process on a port sequentially selected from the ports, the readout amount supply process including:
selecting a flow from first flows corresponding to the selected port, and
supplying the allowable readout amount to the selected flow, wherein
the processor controls execution of the readout amount supply process so that the allowable readout amount increases when the selected flow is a flow whose bandwidth is guaranteed, and the allowable readout amount is also supplied to each of flows other than the selected flow within the first flows before a next port is selected from the ports when the selected flow is a flow whose bandwidth is not guaranteed.

2. The bandwidth control device of claim 1, wherein
the processor executes the readout amount supply process such that the supplying the allowable readout amount to the selected flow is executed based on a bandwidth amount allocated for each of the ports, and
in a case where the selected flow is a flow whose bandwidth is not guaranteed, the processor controls the execution of the readout amount supply process so that the supplied allowable readout amount increases when a bandwidth amount of the selected port is greater than a predetermined amount, and the allowable readout amount is also supplied to flows other than the selected flow within the first flows before selecting a next port from the ports when the bandwidth amount of the selected port is equal to or less than the predetermined amount.

3. The bandwidth control device of claim 2, wherein
the processor controls the execution of the readout amount supply process so that an interval at which a bandwidth amount is allocated is extended.

4. The bandwidth control device of claim 1, wherein
the processor is further configured to monitor a load of executing the readout amount supply process; and
the processor controls the execution of the readout amount supply process according to a result of monitoring the load of executing the readout amount supply process.

5. The bandwidth control device of claim 4, wherein
when the load exceeds a predetermined threshold value, the processor controls the execution of the readout amount supply process so that the supplied allowable readout amount increases by a fixed amount.

6. The bandwidth control device of claim 5, wherein
when the load is equal to or less than the predetermined threshold value, the processor controls the execution of the readout amount supply process so that the supplied allowable readout amount is restored to a value before the supplied allowable readout amount increases.

7. The bandwidth control device of claim 4, wherein
the processor controls the execution of the readout amount supply process so that the supplied allowable readout amount increases as the load increases.

8. The bandwidth control device of claim 5, wherein
the processor is further configured to request a fixed value of the allowable readout amount from the readout amount supply process each time a packet is input to each of the plurality of queues; and
the processor causes the readout amount supply process to:
accept requests from the processor in batches for each of the plurality of flows, and
supply the allowable readout amount in accordance with the accepted request when the load exceeds the predetermined threshold value.

9. The bandwidth control device of claim 8, wherein
the processor causes the readout amount supply process to:
accept requests in batches in accordance with a priority level that is determined based on a total sum of the allowable readout amounts requested by the processor, and
supply the allowable readout amount in accordance with the accepted requests.

10. A bandwidth control system comprising:
a first processing device including a memory and a first processor coupled to the memory; and
a second processing device including a second processor that communicates with the first processor through a network, wherein
the memory of the first processing device is configured to include a plurality of queues each configured to store packets for different one of a plurality of flows;
the first processor is configured to read out packets from each of the plurality of queues according to an allowable readout amount supplied for a flow corresponding to the each queue, and output the packets to one of ports corresponding to the flow, the allowable readout amount being an amount of data for packets that are allowed to be read out at one time from a queue; and
the second processor is configured to execute a readout amount supply process on a port sequentially selected from the ports, the readout amount supply process including:
selecting a flow from first flows corresponding to the selected port, and
supplying the allowable readout amount to the selected flow, wherein
the second processor controls execution of the readout amount supply process so that the allowable readout amount increases when the selected flow is a flow whose bandwidth is guaranteed, and the allowable readout amount is also supplied to each of flows other than the selected flow within the first flows before a next port is selected from the ports when the selected flow is a flow whose bandwidth is not guaranteed.

11. The bandwidth control system of claim 10, wherein
the second processor executes the readout amount supply process such that the supplying the allowable readout amount to the selected flow is executed based on a bandwidth amount allocated for each of the ports; and
in a case where the selected flow is a flow whose bandwidth is not guaranteed, the processor controls the execution of the readout amount supply process so that the supplied allowable readout amount increases when a bandwidth amount of the selected port is greater than a predetermined amount, and the allowable readout amount is also supplied to flows other than the selected flow within the first flows before selecting a next port from the ports when the bandwidth amount of the selected port is equal to or less than the predetermined amount.

12. The bandwidth control system of claim 11, wherein
the second processor controls the execution of the readout amount supply process so that an interval at which the bandwidth amount is allocated is extended.

13. The bandwidth control system of claim 10, wherein
the second processor is further configured to monitor a load of executing the readout amount supply process, and
the second processor controls the execution of the readout amount supply process according to a result of monitoring the load of executing the readout amount supply process.

14. The bandwidth control system of claim 13, wherein
when the load exceeds a predetermined threshold value, the second processor controls the execution of the readout amount supply process so that the supplied allowable readout amount increases by a fixed amount.

15. The bandwidth control system of claim 14, wherein
when the load is equal to or less than the predetermined threshold value, the second processor controls the execution of the readout amount supply process so that the supplied allowable readout amount is restored to a value before the supplied allowable readout amount increases.

16. The bandwidth control system of claim 13, wherein
the second processor controls the execution of the readout amount supply process so that the supplied allowable readout amount increases as the load increases.

17. The bandwidth control system of claim 14, wherein
the first processor is further configured to request a fixed value of the allowable readout amount from the readout amount supply process each time a packet is input to each of the plurality of queues; and
the second processor causes the readout amount supply process to:
accept requests from the processor in batches for each of the plurality of flows, and
supply the allowable readout amount in accordance with the accepted request when the load exceeds the predetermined threshold value.

18. The bandwidth control system of claim 17, wherein
the second processor causes the readout amount supply process to:
accept requests in batches in accordance with a priority level that is determined based on a total sum of the allowable readout amounts requested by the processor, and
supply the allowable readout amount in accordance with the accepted requests.
